(19) United States
(12) Patent Application Publication
(10) Pub. No.: US 2007/0259163 A1
(43) Pub. Date: Nov. 8, 2007

(54) PRESSURE-SENSITIVE ADHESIVE ARTICLES WITH NON-WOVEN BACKING HAVING AN ELASTOMETRIC BINDER

(75) Inventors: John Connolly, Peabody, MA (US); Thomas S. Murphy, Boxford, MA (US); Paul Taylor, North Andover, MA (US)

Correspondence Address: WILMER CUTLER PICKERING HALE AND DORR LLP, 60 STATE STREET, BOSTON, MA, 02109, US

(73) Assignee: Andover Healthcare, Inc., Salisbury, MA (US)

(21) Appl. No.: 11/693,547

(22) Filed: Mar. 29, 2007

Related U.S. Application Data
(60) Provisional application No. 60/787,991, filed on Mar. 31, 2006.

(51) Int. Cl. B32B 7/12; B32B 27/00; B32B 3/26

(52) U.S. Cl. 428/219; 428/220; 428/304.4; 428/343; 442/2; 442/327; 442/400; 442/401

(57) ABSTRACT

Pressure-sensitive adhesive articles with a backing that provides secure but reversible adhesion to the pressure-sensitive face of the article when the article is wound upon itself to form a roll. Such “non-stick” backings include a non-woven fabric carrying a binder, such as polychloroprene, butadiene-styrene copolymer or butadiene-styrene-acrylonitrile copolymer, that provides a soft and conformable layer that readily releases from an overlying adhesive layer of the article when the rolled article is unwound.

### CROSS-REFERENCE TO RELATED APPLICATIONS

This application claims the benefit under 35 U.S.C. §119(e) of U.S. Provisional Patent Application No. 60/787,991, filed on Mar. 31, 2006, entitled “Pressure Sensitive Adhesive Article with Non-Woven Backing Having Elastomeric Binder”, which is incorporated herein by reference in its entirety.

### FIELD OF THE INVENTION

The present invention generally relates to the field of pressure-sensitive adhesive articles, and specifically to pressure-sensitive adhesive articles such as tapes and bandages.

### BACKGROUND

Pressure-sensitive adhesive articles are typically made up of an adhesive composition layer and a backing layer. The use of pressure-sensitive adhesive-coated sheet materials in the form of adhesive tapes, medical and surgical bandages, and surgical drapes for the management of skin wounds, as well as to adhere or to secure medical devices such as intravenous needles, is a widely used and well-accepted medical practice. Pressure-sensitive adhesive-coated tapes are also widely used in sports medicine for protection and safety of athletes, for example, for the wrapping of joints subject to stress during performance, as well as for treating injuries.

Some tapes are designed to be breathable, so that if they are used on skin, moisture is allowed to vent from the skin. This can help to prevent skin damage. Some tapes are designed to be evenly tearable in the cross direction, in some cases by hand force alone. Certain properties of breathability, adhesiveness, strength, and facile tear may be desirable, but tape compositions must comport with the physical requirements for efficient commercial manufacture as well as facile consumer use.

### SUMMARY OF THE INVENTION

The present invention provides pressure-sensitive adhesive articles having “non-stick” backings. The invention is based in part upon the finding that pressure-sensitive adhesive articles having backings made with non-woven fabric carrying particular elastomeric binder compositions possess especially desirable properties of unwind peel force when combined with a pressure-sensitive adhesive layer to form an article, which is then rolled upon itself into a tape roll.

Under one aspect, an adhesive article with a nonstick backing includes a backing, which includes a first non-woven fabric that carries a binder. The binder includes an elastomer selected from the group consisting of polychloroprene, butadiene-styrene copolymer, butadiene-styrene-acrylonitrile copolymer, and mixtures thereof. The article also includes a pressure-sensitive adhesive layer applied to a surface of the backing. The adhesive layer includes a fabric or a second non-woven fabric carrying a pressure-sensitive adhesive. The adhesive layer can be laminated or bonded to the backing.

In some embodiments, the backing of the assembled article reversibly adheres to the adhesive layer of another such adhesive article. The article can be wound upon itself to form overlying layers, and the backing can be on the outside of the wound article. In some embodiments, the backing is selected so that if the article is wound upon itself to form overlying layers, when the article is unwound the backing releases from an overlying adhesive layer without undue force, for example, with ordinary hand force. The backing of an underlying layer of the adhesive article can release from the adhesive layer of an overlying layer of the adhesive article without separating from the adhesive layer applied to the surface of the backing.

In some embodiments, if the article is wound upon itself to form overlying layers under standard test conditions, the backing releases from the overlying adhesive layer with an unwinding force of about 20 ounces/inch-width in a standard unwind force test. The standard test condition can include a winding force of about 25 ounces/inch-width. In some embodiments, if the article is wound upon itself to form overlying layers under standard test conditions, the backing releases from the overlying adhesive layer with an unwinding force of less than about 35 ounces/inch-width in a standard unwind force test.

In some embodiments, if the article is wound upon itself to form overlying layers, the pressure-sensitive adhesive provides an overlap adhesion and shear strength sufficient to prevent unwind of the wound article without the use of sufficient force. The type and amount of pressure-sensitive adhesive can be selected to provide an overlap adhesion and shear strength sufficient to provide a peel strength of about 9 ounces/inch-width in a standard peel strength test. The standard peel strength test can include rolling the article five times with a 5 pound roller. The type and amount of pressure-sensitive adhesive can be selected to provide an overlap adhesion and shear strength sufficient to provide a shear strength of about 16 pounds/inch² in a standard shear strength test. The standard shear strength test can include rolling the article five times with a 5 pound roller.

In some embodiments, the type and amount of pressure-sensitive adhesive are selected to adhere the adhesive layer to the backing with a strength sufficient to allow for orthopedic support in a joint strapping application. The article can be soft and conformable and/or pliable. The article can be suitable for strapping.

In some embodiments, the adhesive layer has a porosity greater than that of the backing. For example, the adhesive layer can have an overall open area of at least about 15% of the article, and/or the backing can have at least about 10% open area. The article can have an overall air permeability of at least about 100 ft³/minute, and/or a water vapor transfer rate of at least about 1,000 grams/day-m², or at least about 1,400 grams/day-m².

In some embodiments, the backing and adhesive layer are selected so that the article is hand-tearable in at least one of the transverse and longitudinal directions. The fabric of the adhesive layer can include warp yarns running in the machine direction and weft yarns running in the cross direction, the weft yarns having a higher denier than the warp yarns. The warp yarns can have a denier in the range of 20 to 80, and the weft yarns can have a denier in the range of 50 to 200. The warp yarns can have a density in the range of 9 yarns/inch to 24 yarns/inch, and wherein the weft yarns can have a density in the range of 9 yarns/inch to 18 yarns/inch. The warp yarns can have a denier of about 30 and a density of about 18 yarns/inch, and the weft yarns can have a denier of about 70 and a density of about 12 yarns/inch.

In some embodiments, the article is elastic. For example, the article can also include an elastic layer applied to at least one of the backing and the adhesive layer. The elastic layer can be laminated to at least one of the backing and the adhesive layer, and can be positioned between the first non-woven fabric and the adhesive layer. In some embodiments, the elastic layer is elastic in a direction extending longitudinally of the article. For example, the elastic layer can include individual elastic strands spaced transversely of the article relative to each other and extending longitudinally of the article. The article can be longitudinally extensible by at least about 10% during normal use, by at least about 20% during normal use, or by at least about 100% during normal use and/or in a standard extensibility test. The extensibility test can include measuring the % stretch of a 10 cm×30 cm piece of the article that occurs upon application of 5 lb of force along a 10 cm edge of the piece of the article.

In some embodiments, the article is substantially non-elastic. In some embodiments, the backing of the article also includes a warp-knit weft-insertion or woven scrim fabric laminated to the first non-woven fabric. The binder can laminate the warp-knit weft-insertion or woven scrim fabric to the first non-woven fabric, and/or can substantially lock the fibers of the warp-knit weft-insertion or woven scrim fabric so as to provide for effective hand-tear. The warp-knit weft-insertion or woven scrim fabric can be positioned between the first non-woven fabric and the adhesive layer, or the first non-woven fabric can positioned between the warp-knit weft-insertion or woven scrim fabric and the adhesive layer. The warp-knit weft-insertion or woven scrim fabric can include polyester and/or can have a weight of about 18 g/m².

In some embodiments, the binder substantially coats the outer surface of the first non-woven fabric. The binder can be cohesive. In some embodiments, the binder includes polychloroprene, which includes poly-2-chloro-1,4-butadiene monomeric units. The binder can include polychloroprene, non-silicone defoamer, titanium dioxide whitener, antioxidant, and thickener. In some embodiments, the binder includes butadiene-styrene random copolymer and/or butadiene-styrene-acrylonitrile random copolymer.

In some embodiments, the first non-woven fabric is porous. The first non-woven fabric can have a weight of about 7.5 g/m² to about 30 g/m², or a weight of about 10 g/m². The first non-woven fabric can include at least one of polypropylene, nylon, polyester, and cellulose. The polypropylene can include at least one of wet laid, meltblown, and spunbond polypropylene.

In some embodiments, the pressure-sensitive adhesive substantially coats the outer surface of the fabric or second non-woven fabric of the adhesive layer. The pressure-sensitive adhesive can include a solvent-based pressure-sensitive adhesive and/or a water-based pressure-sensitive adhesive. The pressure-sensitive adhesive can include at least one of acrylonitrile-butadiene copolymer, styrene-butadiene copolymer, acrylic polymer, natural rubber latex, and synthetic rubber latex. For example, the pressure-sensitive adhesive can include about 16% to about 36% natural rubber latex, or about 26% natural rubber latex. The pressure-sensitive adhesive can include a mixture of natural rubber latex and synthetic rubber latex. The mixture of natural rubber latex and synthetic rubber latex can make up about 30% to about 70% of the pressure-sensitive adhesive, or about 54% of the pressure-sensitive adhesive. The pressure-sensitive adhesive can include natural rubber latex, which reduces adhesion between the backing and the adhesive layer.

In some embodiments, the pressure-sensitive adhesive also includes a tackifier. The tackifier can include a low molecular weight, aliphatic tackifying resin, which can be derived from at least one of a diene and a reactive olefin monomer. The tackifier can include a solvent-free anionic hydrocarbon dispersion prepared from aliphatic C₅ hydrocarbon resin. The tackifier can include a rosin ester, such as a glycerol ester of rosin.

In some embodiments, the fabric or second non-woven fabric of the adhesive layer is porous. The fabric or second non-woven fabric of the adhesive layer can be a high-strength, low stretch fabric. The fabric of the adhesive layer can include a warp-knit weft-insertion fabric and/or a woven scrim fabric. The fabric or second non-woven fabric of the adhesive layer can include at least one of polyester, polypropylene, and polyamide. The fabric or second non-woven fabric of the adhesive layer can have a weight of about 18 g/m² and/or at least about 25% open area.

Under another aspect, an adhesive article with a nonstick backing includes a backing, which includes a first non-woven fabric carrying a binder. The binder includes an elastomer selected from the group consisting of polychloroprene, butadiene-styrene copolymer, butadiene-styrene-acrylonitrile copolymer, and mixtures thereof. The article also includes a pressure-sensitive adhesive layer coextensive with the backing. The adhesive layer includes a fabric or a second non-woven fabric carrying a pressure-sensitive adhesive. The article also includes an elastic layer in contact with at least one of the backing and the adhesive layer.

In some embodiments, the binder includes a mixture of polychloroprene and butadiene-styrene copolymer. For example, the binder can include about 51 weight % polychloroprene and about 43 weight % butadiene-styrene copolymer.

In some embodiments, the elastic layer is laminated to at least one of the backing and the adhesive layer. The elastic layer can be elastic in a direction extending longitudinally of the article. The elastic layer can include individual elastic strands spaced transversely of the article relative to each other and extending longitudinally of the article. The elastic layer can be positioned between the backing and the adhesive layer. The backing and adhesive layer can partially contact each other through open areas in the elastic layer. In some embodiments, the elastic layer includes at least one of: lycra, spandex, polyester, natural rubber, polyisoprene, polybutadiene, diene-styrene copolymer, diene-acrylonitrile copolymer, polychloroprene, elastomeric ethylenepropylene copolymer, styrene-butadiene block copolymer, styrene-isoprene block copolymer, elastic polyurethane yarn, polyether type urethane, and polyester type urethane.

Under another aspect, an adhesive article with a nonstick backing includes a backing, which includes a warp-knit weft insertion or woven scrim fabric and a first non-woven fabric carrying a binder. The binder includes an elastomer selected from the group of polychloroprene, butadiene-styrene copolymer, butadiene-styrene-acrylonitrile copolymer, and mixtures thereof. The article also includes a pressure-sensitive adhesive layer coextensive with the backing. The adhesive layer includes a fabric or a second non-woven fabric carrying a pressure-sensitive adhesive.

In some embodiments, wherein the article is extensible by less than about 2%, less than about 1%, or less than about 0.5%. The article can have these extensibilities, for example, when the article is wet and/or dry, during normal use and/or until failure. Wetting the article may not substantially alter the extensibility of the article. For example, wetting the article can change the extensibility of the article by less than about 0.5% at a tensile force of 5 pounds. These extensibilities can be in a direction longitudinal of the article.

Under another aspect, an adhesive article with a nonstick backing includes a pressure-sensitive adhesive layer. The adhesive layer includes a fabric or a first non-woven fabric carrying a pressure-sensitive adhesive. The article also includes a backing bonded to the adhesive layer. The backing includes a second non-woven fabric carrying a binder. The backing is soft and conformable and the binder provides suitable adhesive properties. When the article is wound upon itself to form overlying layers, the backing of an article layer bonds sufficiently weakly to the adhesive layer of an overlying article layer so as to release from the overlying adhesive layer without undue force when unwinding the wound article. Additionally, when the article is wound upon itself to form overlying layers, the backing of an article layer bonds sufficiently strongly to the adhesive layer to which it is bonded as not to separate from said adhesive layer when unwinding the wound article.

In some embodiments, the binder includes an elastomer. The elastomer can contribute to the described release and separation properties of the backing. The elastomer can include at least one of polychloroprene, butadiene-styrene copolymer, butadiene-acrylonitrile copolymer, butadiene-styrene-acrylonitrile copolymer, natural rubber latex, non-pressure sensitive acrylic, waterborne polyurethane, ethylene-vinyl acetate copolymer, and mixtures thereof. The elastomer can include at least one of polychloroprene, butadiene-styrene copolymer, butadiene-styrene-acrylonitrile copolymer, and mixtures thereof.

Under one aspect, a method of making an adhesive article includes coating a fabric or a first non-woven fabric with a pressure-sensitive adhesive to form a pressure-sensitive adhesive layer. The method also includes coating a second non-woven fabric with a binder to form a backing. The backing is soft and conformable, and the binder provides suitable adhesive properties. When the article is wound upon itself to form overlying layers, the backing of an article layer bonds sufficiently weakly to the adhesive layer of an overlying article layer so as to release from the overlying adhesive layer without undue force when unwinding the wound article. Additionally, when the article is wound upon itself to form overlying layers, the backing of an article layer bonds sufficiently strongly to the adhesive layer to which it is bonded as not to separate from said adhesive layer when unwinding the wound article. The method also includes bonding the adhesive layer to the backing to form a pressure-sensitive adhesive article.

In some embodiments, the binder comprises an elastomer. The elastomer can include at least one of polychloroprene, butadiene-styrene copolymer, butadiene-acrylonitrile copolymer, butadiene-styrene-acrylonitrile copolymer, natural rubber latex, non-pressure sensitive acrylic, waterborne polyurethane, ethylene-vinyl acetate copolymer, and mixtures thereof. The elastomer can include at least one of polychloroprene, butadiene-styrene copolymer, butadiene-styrene-acrylonitrile copolymer, and mixtures thereof. The polychloroprene can include poly-2-chloro-1,4-butadiene monomeric units. The binder can include polychloroprene, non-silicone defoamer, titanium dioxide whitener, antioxidant, and thickener. In some embodiments, the binder includes butadiene-styrene random copolymer and/or butadiene-styrene-acrylonitrile random copolymer.

In some embodiments, coating the second non-woven fabric with the binder includes saturating the second non-woven fabric with the binder. In some embodiments, coating the fabric or the first non-woven fabric of the adhesive layer with the pressure-sensitive adhesive includes saturating the fabric or the first non-woven fabric of the adhesive layer with the pressure-sensitive adhesive.

In some embodiments, the method also includes laminating a warp-knit weft-insertion or woven scrim fabric to the second non-woven fabric. The binder can laminate the warp-knit weft insertion or woven scrim fabric to the second non-woven fabric. The warp-knit weft-insertion or woven scrim fabric can be positioned between the second non-woven fabric and the fabric or first non-woven fabric of the adhesive layer before bonding the backing to the adhesive layer. The binder can substantially lock the fibers of the warp-knit weft-insertion or woven scrim fabric so as to provide for effective hand tear in the article.

In some embodiments, the method also includes laminating an elastic layer to at least one of the backing and the adhesive layer. The elastic layer can be positioned between the backing and adhesive layer before bonding the backing to the adhesive layer. The adhesive layer can least partially contact the backing through open spaces in the elastic layer. The elastic layer can include individual elastic strands spaced transversely of the article relative to each other and extending longitudinally of the article.

In some embodiments, the pressure-sensitive adhesive coated on the fabric is about 50% dry when bonding the adhesive layer to the backing. The method can include drying the article. The method can include winding the article upon itself to form a roll.

Under another aspect, an adhesive article with a non-stick backing is made by the process of coating a fabric or a first non-woven fabric with a pressure-sensitive adhesive to form a pressure-sensitive adhesive layer. The process also includes coating a second non-woven fabric with a binder to form a backing, where the backing is soft and conformable, and the binder provides suitable adhesive properties. When the article is wound upon itself to form overlying layers, the backing of an article layer bonds sufficiently weakly to the adhesive layer of an overlying article layer so as to release from the overlying adhesive layer without undue force when unwinding the wound article. Additionally, when the article is wound upon itself to form overlying layers, the backing of an article layer bonds sufficiently strongly to the adhesive layer to which it is bonded as not to separate from said adhesive layer when unwinding the wound article. The process also includes bonding the adhesive layer to the backing to form a pressure-sensitive adhesive article.

In some embodiments, the binder includes an elastomer. The elastomer can contribute to the described release and separation properties of the backing. The elastomer can include at least one of polychloroprene, butadiene-styrene copolymer, butadiene-acrylonitrile copolymer, butadiene-styrene-acrylonitrile copolymer, natural rubber latex, non-pressure sensitive acrylic, waterborne polyurethane, ethylene-vinyl acetate copolymer, and mixtures thereof. The elastomer can include at least one of polychloroprene, butadiene-styrene copolymer, butadiene-styrene-acrylonitrile copolymer, and mixtures thereof.

In some embodiments, the article is wound upon itself to form overlying layers. The backing can be on the outside of the wound article. The backing of an article layer can bond sufficiently weakly to the adhesive layer of an overlying article layer so as to release from the overlying adhesive layer with ordinary hand force.

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the state value with a variance of 10%.

### BRIEF DESCRIPTION OF THE DRAWINGS

In the Drawing:

FIG. 1A is an enlarged plan view of a portion of a pressure-sensitive adhesive tape with “non-stick” backing according to one or more embodiments.

FIG. 1B is a cross-sectional view of the pressure-sensitive adhesive article of FIG. 1A shown at cross-section 1-1.

FIG. 2 is an enlarged plan view of a portion of a pressure-sensitive adhesive article with “non-stick” backing according to one or more embodiments.

FIG. 3 is an enlarged plan view of a portion of a non-elastic pressure-sensitive adhesive article with “non-stick” backing according to one or more embodiments.

FIG. 4 is an enlarged plan view of a portion of an elastic pressure-sensitive adhesive article with “non-stick” backing according to one or more embodiments.

FIG. 5 is a flow-chart of a method of making an optionally non-elastic pressure-sensitive adhesive article with a “non-stick” backing according to one or more embodiments.

FIG. 6 is a flow-chart of a method of making an elastic pressure-sensitive adhesive article with a “non-stick” backing according to one or more embodiments.

FIG. 7 shows diagrammatically an apparatus for producing the backing of a non-elastic pressure-sensitive adhesive article with a “non-stick” backing according to one or more embodiments.

FIG. 8 shows diagrammatically an apparatus for producing a pressure-sensitive adhesive article with a “non-stick” backing according to one or more embodiments.

FIG. 9 shows diagrammatically an apparatus for producing the backing of an elastic pressure-sensitive adhesive article with a “non-stick” backing according to one or more embodiments.

FIG. 10 shows diagrammatically an apparatus for producing an elastic pressure-sensitive adhesive article with a “non-stick” backing according to one or more embodiments.

FIG. 11A shows the results of multiple peel force measurements of the force needed to release tape backings made with binders which incorporate the indicated elastomeric compositions (using Acronal® 3432, Hartex 101, Dispercoll® C-74, Macekote 9252, Styrofan® 4710, or Degree 100A) from the adhesive surface #150 Trainer Tape as a function of the cohesive coat weight of the binder coated to the backing.

FIG. 11B presents a table summarizing the individual sample weights, sample lengths, sample widths, adhesive weights, and peel force measurements for each of the samples that are reported in FIG. 11A.

FIG. 12A shows a plot of the measured peel force, shear force, tensile strength, unwind force, and article weight for an example non-elastic pressure-sensitive adhesive article with a binder that incorporates a polychloroprene elastomer composition (Dispercoll® C-74), wound at a variety of rewinding tensions (35, 28, and 25 ounces/inch-width).

FIG. 12B presents a table of the measured peel force, shear force, tensile strength, unwind force, and article weight for the example adhesive article that is reported in FIG. 12A.

FIG. 13 shows a plot of the results of standard unwind force test measurements made on an example non-elastic pressure-sensitive adhesive article with a polychloroprene-based binder (Dispercoll® C-74), wound at a variety of rewinding tensions (35, 28, and 25 ounces/inch-width), as a function of the coat weight (in g/m²) of the article.

FIG. 14A presents a table of the results of standard unwind force, peel adhesion, shear adhesion, and tensile strength measurements made on an example non-elastic pressure-sensitive adhesive articles with a polychloroprene-based binder (Dispercoll® C-74), wound at a variety of rewinding tensions (35 and 28 ounces/inch-width).

FIG. 14B presents a table of the results of standard unwind force, peel adhesion, and shear adhesion measurements made on an example non-elastic pressure-sensitive adhesive articles with a polychloroprene-based binder (Dispercoll® C-74), wound at a rewind tension of 25 ounces/inch-width.

FIG. 15 shows the results of peel face to backing (Pfb) test measurements for nonelastic tapes having a backing with a polychloroprene-based binder (Dispercoll® C-74) with (squares and X's) and without (diamonds and triangles) 2% added defoamer present in the binder of the backing as measured when applied to two different pressure-sensitive adhesive layers—one being the adhesive layer of #150 Trainer Tape (made with H310W pressure-sensitive adhesive) (diamonds and squares) and one made with 2023-52-B pressure-sensitive adhesive (triangles and Xs).

FIG. 16A shows the results of percent stretch measurements (STRETCH—%) as a function of applied tension (TENSILE—lbs) for a nonelastic tape (EX 3042B) having a backing with a polychloroprene-based binder (Dispercoll® C-74) when dry (Xs and light line, as indicated) and when dry (Xs and darker line, as indicated) as compared to the same measurements for another commercial tape (J&J Coach) when dry (Xs and lightest line, as indicated) and when wet (Xs and darkest line, as indicated).

FIG. 16B shows a plot of the results of percent stretch measurements (STRETCH—%) as a function of applied tension (TENSILE—lbs) for a nonelastic tape (EX 3042B) having a backing with a polychloroprene-based binder (Dispercoll® C-74) when dry (Xs and light line, as indicated) and when dry (Xs and darker line, as indicated) as compared to the same measurements for another commercial tape (J&J Zonas) when dry (Xs and lightest line, as indicated) and when wet (Xs and darkest line, as indicated).

FIG. 17 shows a plot of the results of a standard water vapor transmission measurement (ASTM E96-00) made on an example non-elastic pressure-sensitive adhesive tape with a polychloroprene-based backing (Dispercoll® C-74), as well as on select commercially available alternative articles (J&J Zonas Porous, J&J Coach, and #150 Trainer Tape (TT)).

### DETAILED DESCRIPTION

The present invention provides pressure-sensitive adhesive tapes or articles having backings with a releasable outer surface, which are at once both convenient to use and economical to manufacture. One surface of an adhesive article, according to certain embodiments, includes a fabric carrying a pressure-sensitive adhesive, to form an adhesive layer. The other surface of the article includes a non-woven fabric carrying a binder, to form a backing layer that is applied to and coextensive with the adhesive layer. The backing layer is bonded or laminated to the adhesive layer, so that the two layers do not come apart during use, e.g., while the article is being used as supportive ankle strapping. However, the backing has particularly useful adhesive properties so that, when the article is wound up to form a roll, application of a light force, e.g., hand force, is sufficient to unwind the roll. Accordingly, the backing might be said to have a “non-stick” characteristic, although this is to be understood to mean that the backing allows firm, albeit easily reversible, adhesion to the pressure-sensitive adhesive layer side of the article such that the roll does not spontaneously unwind, but is easily unwound by a human user. Furthermore, while overlying layers of the article in the roll separate easily from one another, the binder and adhesive layer of any given layer of the article do not separate from each other during unwind. Additionally, the roll does not inadvertently unwind without the use of sufficient force, making it easy to transport and handle. In summary, the adhesive article can be wound into a roll, easily handled as a roll, and subsequently unwound and used while maintaining structural integrity. Moreover, the adhesive article is soft to the touch and comfortable to use against skin. The article is also typically breathable and provides a high water vapor transmission rate to prevent sweat-induced failure and/or skin maceration, particularly for athetic applications. The article is typically also pliable and/or conformable.

The kinds and amounts of materials used in the backing and the adhesive layer impart various characteristics to the finished article. The fabrics used in the backing and the adhesive layer allow the article to be conveniently torn by hand in a direction transverse to and/or longitudinal to the direction of the article. An article intended for use as a supportive strapping tape may be made substantially non-elastic by selecting a backing material that is relatively non-elastic, or even by incorporating non-elastic materials into the article, such as a warp-knit weft-insertion or woven scrim fabric. Or, an article intended for use as a stretch bandage can be made elastic by including an elastic layer in the article. These and other adhesive articles with “non-stick” backings, and methods of making same, are described in greater detail below. Additionally, some standard methods of testing the mechanical characteristics of adhesive articles, and the results of these measurements on finished adhesive articles with “non-stick” backings, fabricated according to certain embodiments, are also described.

Pressure-Sensitive Adhesive Articles with “Non-Stick” Backing

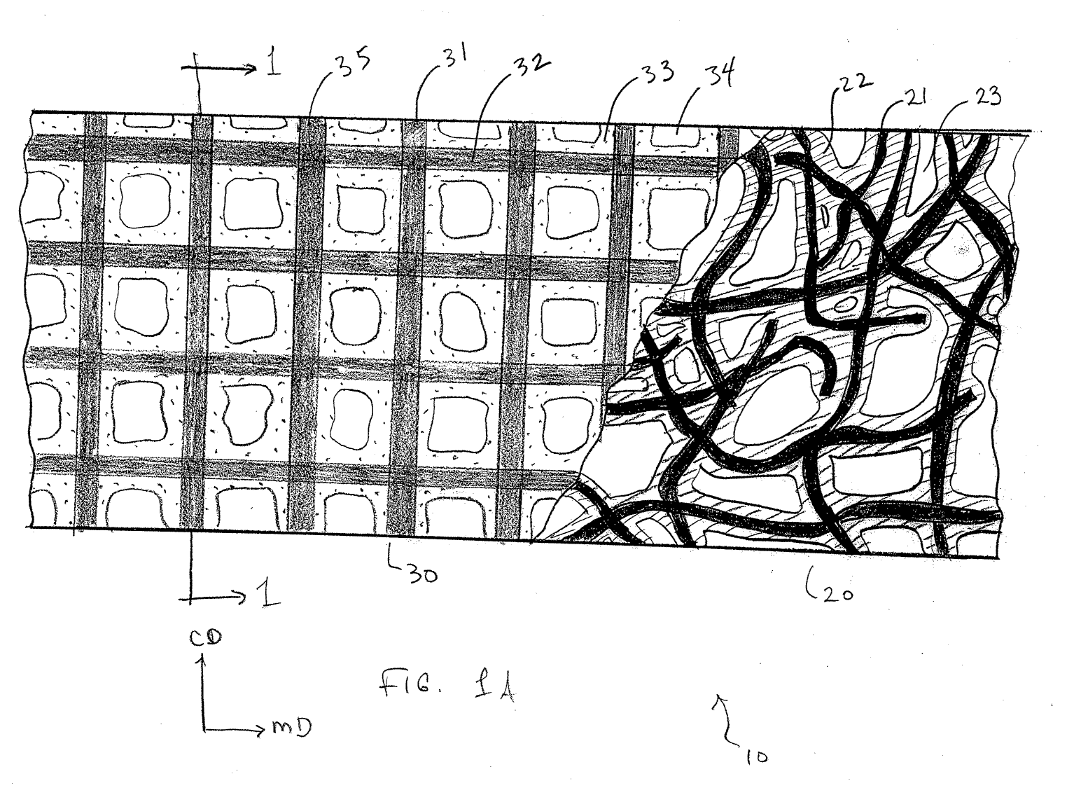

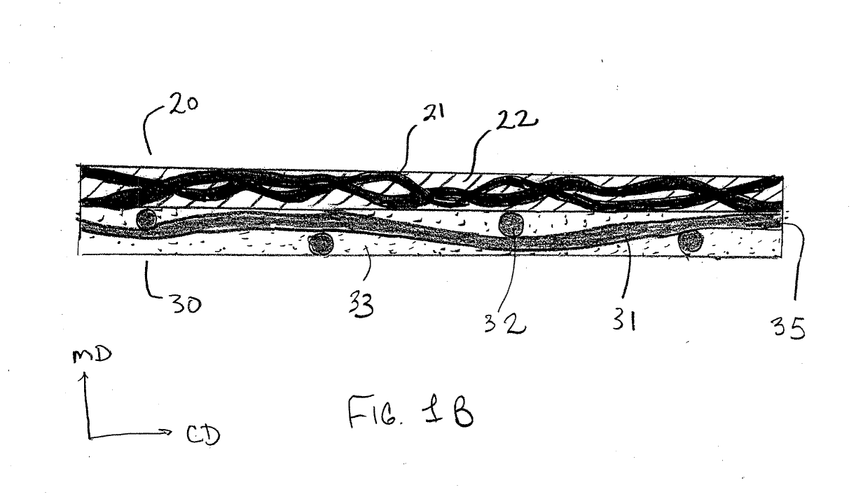

FIG. 1A illustrates a plan view of a pressure-sensitive adhesive article with a “non-stick” backing, according to certain embodiments. It should be understood that this figure and the following figures are not to scale, but rather are intended to be illustrative of the concepts of various embodiments. Article 10 includes backing 20 that is applied to, e.g., laminated or bonded to, adhesive layer 30, so that it overlies and is coextensive with adhesive layer 30. Backing 20 includes non-woven fabric 21, which is porous, and which carries binder 22. Binder 22 substantially coats the outer surfaces of non-woven fabric 21. Optionally, binder 22 is cohesive. The coating of binder 22 does not necessarily fill all of the pores of non-woven fabric 21, leaving open spaces 23 that are substantially free of binder 22. Adhesive layer 30 includes woven scrim 35, which is also porous, and which carries pressure-sensitive adhesive 33. Scrim 35 is made up of weft yarns 31 in the cross direction (CD), transverse to the general orientation of article 10, and warp yarns 32 in the machine direction (MD), longitudinal to the general orientation of article 10. Adhesive 33 substantially coats the outer surfaces of woven scrim 35. The coating of adhesive 33 does not necessarily fill all of the pores of scrim 35, leaving open spaces 34 that are substantially free of adhesive 33. It should be noted that portions of adhesive layer 30 would normally be visible through the open spaces 23 of overlying backing 20, but have been omitted in this figure for clarity of illustration.

FIG. 1B provides a cross-sectional view of the pressure-sensitive adhesive article 10 across line 1-1 of FIG. 1A. In backing 20, binder 22 surrounds and permeates non-woven fabric 21. Although FIG. 1B illustrates the upper and lower surfaces of binder 22 as being flat relative to the top and bottom surfaces of non-woven fabric 21, in some embodiments the surfaces of binder 22 follow contours defined by the yarns of non-woven fabric 22. In adhesive layer 30, adhesive 33 surrounds and permeates the weft (CD) yarns 31 and warp (MD) yarns 32 of woven scrim 35. Although FIG. 1B illustrates the upper and lower surfaces of adhesive 33 as being flat relative to the top and bottom surfaces of woven scrim 35, in some embodiments the surfaces of adhesive 33 follow contours defined by the yarns of woven scrim 35. Additionally, adhesive 33 may partially penetrate into backing 20, which can help to strengthen the bond between backing 20 and adhesive layer 30.

The materials used in binder 22, non-woven fabric 21, adhesive 33, and woven scrim 35 impart various features to article 10. In particular, binder 22 contains an elastomer that helps to impart a “non-stick” character, among other properties, to backing 20. This “non-stick” character allows backing 20 to reversibly adhere to the adhesive layer of another such article 10. In other words, if the adhesive layer 30 of an article 10 is applied on top of the backing 20 of another such article 10 to form a top article 10 and a bottom article 10 construction, then with only a modest amount of force the backing 20 of the bottom article 10 easily releases the adhesive layer 30 of the top article 10. This release does not substantially alter the properties of the adhesive layer 30 of the top article 10, so that the article 10 can be similarly adhered to another surface, for example, the bottom article 10 again. The elastomer in binder 22 of backing 20 contributes to the facile release of the backing from an overlying adhesive layer 30. Thus, if article 10 is wound upon itself to form a roll of overlying layers, when the wound article is unwound the backing 20 releases from an overlying adhesive layer 30 without undue force. In some embodiments, no more than hand force is needed to unroll the wound article. Methods and equipment for quantitatively determining the unwind force of rolled adhesive articles, and actual unwind forces measured for various embodiments of pressure-sensitive adhesive articles with “non-stick” backings, are described in greater detail below.

While the bonding between backing 20 and an overlying adhesive layer 30 is weak, there is still a light amount of adhesion between the two that prevents the inadvertent unwinding of the wound article, e.g., during transportation. In other words, a relatively small but sufficient force needs to be applied to unwind the wound article. Characteristics of the adhesive layer 30 contribute to this light adhesion, and can be quantified by measurements of the overlap adhesion and shear strength of the article. Methods and equipment for quantitatively determining the overlap adhesion and peel strength of adhesive articles, and actual overlap adhesions and peel strengths measured for various embodiments of pressure-sensitive adhesive articles with “non-stick” backings, are described in greater detail below.

While the backing 20 bonds sufficiently weakly to an overlying adhesive layer 30 so as to make article 10 “non-stick”, backing 20 bonds sufficiently strongly to the adhesive layer 30 to which it is applied so that it does not separate from adhesive layer 30 during normal use. This allows the article 10 to be securably used, e.g., in medical applications, or to allow for orthopedic support in a joint strapping application. Additionally, if article 10 is wound or rolled upon itself to form a roll, the wound article can be unwound without causing backing 20 to separate from the adhesive layer 30 to which it is applied (as distinguished from an adhesive layer of an overlying layer of the article). The respective types and amounts of binder 22 and adhesive 33 contribute to the strength of the bond between backing 20 and the adhesive layer 30 to which it is applied. Additionally, the method by which the article is made can help to enhance this bond, as described in greater detail below. For example, adhesive 33 may partially penetrate into backing 20, enhancing the bond between backing 20 and adhesive layer 30. Additionally, the bond between the backing 20 and adhesive layer 30 can be enhanced by lamination.

In certain embodiments, the elastomer in binder 22 is one or more of polychloroprene, butadiene-styrene copolymer, butadiene-styrene-acrylonitrile copolymer, and mixtures thereof. The copolymers can be random copolymers. Other elastomers that can be used in binder 22 include natural rubber latex, non-pressure sensitive acrylic, waterborne polyurethane, butadiene-acrylonitrile copolymer, and ethylene-vinyl acetate copolymer. One example of a useful, commercially available styrene-butadiene copolymer is Rovene® 4150, available from Mallard Creek Polymers, Charlotte, N.C. Rovene® 4150 is an anionic, water-soluble liquid, which is an aqueous dispersion of about 50% carboxylated styrene-butadiene copolymer, which is self-crosslinking, and which has a styrene to butadiene ratio of about 55:45. One example of a useful, commercially available butadiene-acrylonitrile copolymer is Tylac® 68327-00, available from Dow Reichhold Specialty Latex LLC, Research Triangle Park, N.C. Tylac® 68327-00 is a water-soluble liquid, which is an aqueous dispersion of about 55% carboxylated styrene-butadiene-acrylonitrile copolymer. One example of a useful, commercially available non-pressure sensitive acrylic is Hycar® 2671 emulsion, available from Noveon, Inc., Cleveland Ohio. One example of a useful, commercially available waterborne polyurethane is Macekote 9252, available from Mace Company, Dudley, Mass.

Polychloroprene-based elastomer has been found to impart desirable characteristics to binder 22, particularly when, e.g., greater than 50%, greater than 90%, about 97%, or more of the polychloroprene are poly-2-chloro-1,4-butadiene monomeric units (polymerized chloroprene, CAS No. 126-99-8). An example of a useful, commercially available elastomer is Dispercoll® C-74 polychloroprene latex, available from Bayer MaterialScience LLC, Pittsburgh, Pa. Dispercoll® C-74 is provided as a water-soluble liquid, which is an aqueous dispersion of about 55-58% polychloroprene, in addition to trace amounts of other chemicals. About 97% of the monomeric units of the polychloroprene in Dispercoll® C-74 are poly-2-chloro-1,4-butadiene monomeric units. About 85% of the monomeric units are poly-2-chloro-trans-1,4-butadiene monomeric units, and about 15% of the monomeric units are poly-2-chloro-cis-1,4-butadiene monomeric units. The remainder of the monomeric units of the polychloroprene are about 1.5% of a mixture of poly-2-chloro-1,2-butadiene and poly-4-chloro-1,2-butadiene monomeric units, and about 1.0% of the monomeric units are poly-2-chloro-3,4-butadiene monomeric units. By “monomeric units” it is meant the individual chemical units, linked together, which make up the polymer. Typically, Dispercoll® C-74 has only about 50-500 ppm of residual 2-chloro-1,4-butadiene monomer (CAS No. 126-99-8). Dispercoll® C-74 is characterized by a medium tendency to crystallize, and a relatively high gel content. Another example of a useful, commercially available polychloroprene elastomer is Neoprene 671A, available from Dupont Performance Elastomers, Wilmington, Del.

Besides the elastomer, binder 22 can contain other compounds that enhance the “non-stick” character of, or otherwise modify the properties of, article 10. In some embodiments, binder 22 includes a defoamer, e.g., a non-silicone defoamer such as sulfonated caster oil. Addition of a defoamer to binder 22 can enhance the release properties of binder 22, in some examples by about 15-20%, as illustrated in greater detail below. One example of a defoaamer that is compatible with the article is Foamaster® NDW, Cognis Corporation, Cincinnati, Ohio. Typically only a small amount of defoamer is needed in order to enhance the release properties of binder 22, for example, less than 5%, less than 2%, about 1.6%, or even less.

In some embodiments, binder 22 includes a whitener, which can give article 10 a more pleasing appearance. One example of a whitener that is compatible with the article is D-583 Titanium Dioxide Dispersion, Heveatex Corporation, Fall River, Mass. This dispersion has a specific gravity of about 1.4 and is about 59% solids. In some embodiments, binder 22 includes an antioxidant, which helps maintain the performance of binder 22 over time. One example of an antioxidant that can be used in binder 22 is Bostex 537, Akron Dispersions, Akron Ohio. Bostex 537 is approximately a 50% aqueous dispersion of Irganox 1010, i.e., tetrakis(methylene(3,5-ditert-butyl-4-hydroxyhydrocinnamate))methane. In some embodiments, binder 22 includes a thickener to adjust its consistency. One example of a thickener that can be used in binder 22 is Paragum-184a 13% solids sodium poly-acrylate blend available from Para-Chem, Simpsonville, S.C.

In some embodiments, binder 22 includes a mixture of elastomer, defoamer, whitener, antioxidant, and/or thickener. For example, one useful formulation for binder 22 includes Dispercoll® C-74 polychloroprene, Foamaster® NDW defoamer, D 583 whitener, Bostex 537 antioxidant, and Paragum-184 thickener.

Adhesive layer 30 includes pressure-sensitive adhesive 33, which typically adheres to most surfaces with very slight pressure, and retains its tackiness. Pressure-sensitive adhesives include a large group of adhesives that utilize many different polymers (acrylics, rubbers, polyurethanes), together with plasticizers and tackifying resins to form a permanently sticky (tacky) adhesive. The name “pressure-sensitive” comes from the fact that moderate pressure alone is sufficient to spread the viscous adhesive layer on to the surface to be adhered to and achieve useful adhesive strength. They form viscoelastic bonds that are aggressively and permanently tacky, and typically adhere without the need of more than finger or hand pressure. Pressure-sensitive adhesives are available in both solvent and latex or water-based forms, and are often based on non-crosslinked rubber adhesives, acrylics, or polyurethanes.

The interaction between pressure-sensitive adhesive 33 and binder 22 partially determines the “non-stick” characteristics of the wound article 10, as well as the strength of bonding between adhesive layer 30 and backing 20. The amounts and kinds of ingredients of pressure-sensitive adhesive 33 are selected to provide appropriate adhesion to backing 20, and target peel strength, which are both desired for use with living skin. Various pressure-sensitive adhesives are compatible with the article, for example, acrylonitrile-butadiene copolymer, styrene-butadiene copolymer, acrylic copolymer, natural rubber latex, and synthetic rubber latex. One example of a useful, commercially available adhesive is Butofan® NS166, BASF, Florham Park, N.J. Butofan® is a styrene-butadiene copolymer, water-based adhesive. Polyacrylate adhesives, polyalphaolefin adhesives, such as linear, radial, branched, and tapered block copolymers including styrene-butadiene, styrene-ethylene/butylenes and styrene-isoprene block copolymers, polyvinyl acrylates, natural and synthetic rubber resin adhesives, silicones, polydiorganosiloxane polyurea copolymers, and mixtures and blends thereof, can also be used.

Natural rubber latex can be useful for reducing adhesion between backing 20 and adhesive layer 30, which can improve the “non-stick” character of article 10. In some embodiments, adhesive 33 includes, e.g., about 16% to 36%, or about 26% natural rubber latex. In some embodiments, adhesive 33 includes a mixture of natural rubber latex and synthetic rubber latex. This mixture can make up a large portion of adhesive 33, e.g., between about 30% to 70%, or about 54%. Natural rubber latex is commercially available, e.g., Hartex 101, from Firestone Natural Rubber Company, Indianapolis, Ind. Hartex 101 is a low ammonia natural latex with trace amounts of zinc oxide and tetramethylthiuram disulfide added as preservatives.

Pressure sensitive adhesives generally include elastomers that are inherently tacky or elastomers or thermoplastic elastomers that include tackifying resins and plasticizing additives. Fillers, antioxidants, stabilizers, and/or crosslinking agents known in the art can also be used. A fluid, typically water, is added to reduce the viscosity of adhesive 33 to a level that is easily applied to woven scrim 35. In some embodiments, adhesive 33 includes a tackifier, which can be a rosin- or hydrocarbon-derived tackifying resin, e.g., a low molecular weight, aliphatic tackifying resin. Some suitable tackifying resins are derived from a diene and/or a reactive olefin monomer. Some suitable tackifying resins are rosin esters, e.g., glycerol rosin esters. One example of a tackifying resin compatible with article 10 is Tacolyn 5085 Resin Dispersion, from Eastman Chemical Company, Kingsport, Tenn. Tacolyn 5085 in an aqueous, 55% solids, solvent-free anionic hydrocarbon dispersion prepared from a low molecular weight, aliphatic C₅ hydrocarbon resin. Another tackifying resin compatible with article 10 is Tacolyn 3280, also available from Eastman Chemical Company. Tacolyn 3280 is an aqueous, 55% solids, solvent-free, anionic rosin ester dispersion prepared from the glycerol ester of a highly hydrogenated rosin.

In some embodiments, adhesive 33 includes a defoamer, which is described in greater detail above. In some embodiments, adhesive 33 includes a surfactant, which helps to emulsify adhesive 33 and to help it better penetrate and coat woven scrim 35. An example of a compatible, commercially available surfactant is Octowet 70PG, from Tiarco Chemical, Dalton Ga. Octowet 70PG is a 70% solution of sodium dioctyl sulfosuccinate (DOSS) in water and propylene glycol. Adhesive 33 can also include a whitener and/or a thickener, which are described above.

In some embodiments, adhesive 33 includes a mixture of adhesive, tackifier, rubber latex, defoamer, surfactant, whitener, and/or thickener. For example, one useful formulation for adhesive 33 includes Butofan® NS166 adhesive, about Tacolyn 5085 tackifier, Hartex 101 natural rubber latex, Foamaster® NDW defoamer, Octowet 70PG surfactant, D 583 whitener, and Paragum-184 thickener.

In addition to having particular “non-stick” and adhesive properties determined in part by binder 22 and adhesive 33, article 10 also has a relatively high overall air permeability and water vapor transfer rate, which are determined in part by the porosities, or open area, of backing 20 and adhesive layer 30. The porosity can help to make the article breathable, and more comfortable for the user, especially for long-term use. In some embodiments, adhesive layer 30 has a greater porosity than that of backing 20. This can help to pull moisture away from the user's skin more rapidly. For example, the adhesive layer can have an overall open area of at least about 15% of the article, and/or the backing can have an overall open area of at least about 10% of the article. By selecting the porosities of backing 20 and adhesive layer 30, the article can be designed to have an overall air permeability of 100 ft³/minute or more, and/or a water vapor transfer rate of at least about 1,000 grams/day-m².

The fabrics selected for use in backing 20 and adhesive layer 30 substantially contribute to the breathability, softness, and weight of article 10. In the non-woven fabric 21 of backing 20, the fibers are intimately entangled with each other to form a coherent, breathable, fibrous fabric. The particular fiber composition used for non-woven fabric 21 is selected from those known in the art, according to the various properties desired. For example, non-woven fabric 21 can include naturally occurring animal and vegetable fiber, including cotton and wool, or synthetic (chemical) fiber such as nylon, cellulosic, rayon, polyester, polyamide, acrylic, polypropylene, polyethylene, and the like, including blends of such fibers. In some embodiments, non-woven fabric 21 includes one or more of polypropylene, nylon, polyester, and cellulosic. Polypropylene non-woven fabrics can include wet laid, meltblown, and spunbond polypropylene. Non-woven fabric 21 can have any weight suitable to provide desired properties to finished article 10. In some embodiments, non-woven fabric 21 is lightweight, with weight of about 7.5 g/m² to about 30 g/m², or about 10 g/m². Suitable non-woven fabrics are readily commercially available, e.g., from Wenzhou Yongdeli Chemical Fibre Products Co., Ltd (Wenzhou, China) or First Quality Nonwovens (Great Neck, N.Y.).

The woven scrim 35 of adhesive layer 30 has an open, porous structure. The openness of scrim 35 is a function of, e.g., the yarn pick count (density) and yarn denier of the scrim, and is selected so that the finished article 10 is porous and air-permeable. It is also selected to provide sufficient adhesive surface area to establish a strong adhesive contact with the backing substrate. In some embodiments, woven scrim 35 is selected to have a relatively high strength and a relatively low stretch. In various embodiments, the fabric is up to about 95% open, i.e., 5% of the surface area is open fabric, or at least 50% open, or at least 25% open.

In some embodiments, scrim 35 exhibits a tensile strength differential in the machine and cross directions of the fabric, allowing for preferential tearing of the finished article 10 in one of these directions. In order to provide warp (MD) yarns 31 and weft (CD) yarns 32 of different tensile strength, yarns of different denier can be used. Denier is a unit of fineness for yarns, based upon 50 milligrams per 450 meters of yarn (1 denier). For fabrics using warp and weft yarns of the same or different material, differences in tensile strength can be achieved by using yarns of different denier, e.g., a “thin” yarn and a “thick” yarn. For example, scrim 35 can include warp yarns 31 in the range of about 20 to 80, 40 to 60, 20 to 40, or about 30 denier, and weft yarns 32 in the range of 50 to 200, 70 to 150, or about 70 denier. In other embodiments, different warp and weft yarn strengths are achieved by using yarns of different filament counts. For example, a low denier filament is used as a warp yarn 31, and a high denier multifilament yarn is used as a weft yarn 32.

In one or more embodiments, woven scrim 35 is characterized by warp yarns 32 of lower tensile strength than the weft yarns 31. The difference in tensile strength gives rise to different tear characteristics in the cross or machine directions; and the arrangement of the weave provides a clean, even tear along the CD. The low stretch characteristics of the MD yarns 32 tend to focus the load at the point of tear and cause the yarns to fail in a predictable manner. The stronger CD yarns 31 tend to guide the tear and cause the tear to propagate between the CD yarns. The CD yarns 32 promote a straight tear across the structure and cause the fibers of the article to break cleanly without a ragged, uneven edge.

The relative strength of article 10 in the cross and machine directions is also influenced by the density of the warp and weft yarns. Accordingly, the overall strength of article 10 in the machine direction can be made higher than that in the cross direction, despite the fact that a weft yarn having a higher denier than that of the warp yarn is utilized. Accordingly, in certain embodiments, the warp yarns 32 can be spaced at a pick count or density of about 9 to 24 yarns per inch as measured transversely of the finished article, e.g., at about 18 yarns per inch. Alternatively, the warp yarns 32 can be spaced at a density in the range of about 12 to 18 yarns per inch, about 18 to 30 yarns per inch, or any other suitable range of densities. Further, the warp yarns can have a denier in the range of about 40 to 80, about 20 to 60, about 40 to 80, about 60 to 100, or any other suitable range of deniers. In one embodiment, the warp yarns 32 have a denier of about 30.

The weft yarns 31 of woven scrim 35 can be spaced at a pick count or density in the range of 9 to 18 yarns per inch as measured longitudinally of the finished article 10. In some embodiments, the weft yarns 31 are at a density of about 12 yarns per inch, or in the range of about 6 to 24, about 12 to 24, about 18 to 36, or about 30 to 48 yarns per inch, of any other suitable range of densities. Further, the weft yarns 31 can have a denier in the range of about 30, or about 50 to 200, about 70 to 150, about 40 to 170, 170 to 300, or any other suitable range of deniers.

The warp yarns 42 and weft yarns 41 are made of any suitable material. For example, in certain embodiments, the yarns are made of one or more of polyolefin, polyester, polycotton, cotton, polypropylene, or any other suitable material that allows for hand-tearing of the finished article while providing the desired tensile strength.

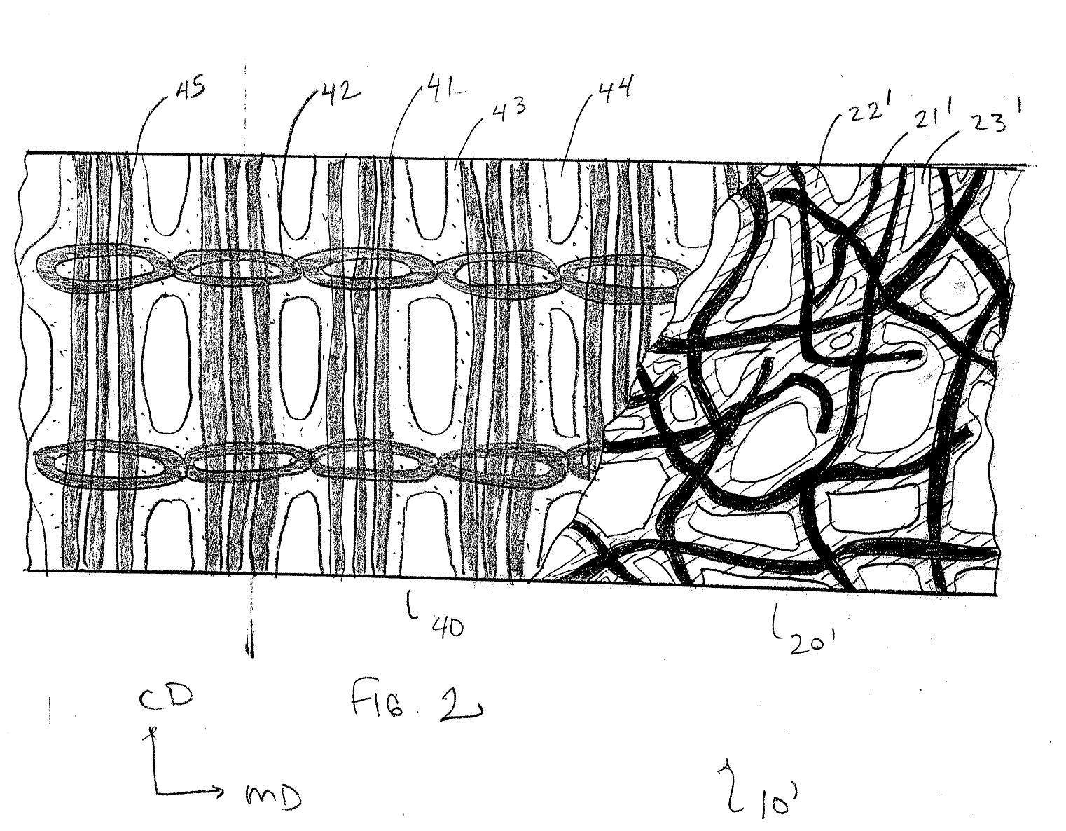

Other fabrics can be used in adhesive layer 30 that also provide the above-described functionality to article 10, such as a knitted fabric, or a non-woven fabric. For example, as shown in FIG. 2, article 10′ includes backing 20′, which is applied to adhesive layer 40. Backing 20′ is substantially the same as described above. Adhesive layer 40 includes warp-knit weft-insertion fabric 45, which is porous and carries pressure-sensitive adhesive 43. Warp-knit weft-insertion fabric 45 is made up of weft yarns 41 in the cross direction (CD), and warp yarns 42 in the machine direction (MD). Adhesive 43 substantially coats the outer surfaces of warp-knit weft-insertion fabric 45, leaving open spaces 44 that are substantially free of adhesive 43. It should be noted that portions of adhesive layer 40 would normally be visible through the open spaces 23′ of overlying backing 20′, but have been omitted in this figure for clarity of illustration.

In warp-knit weft-insertion fabric 45, some yarns 42 are formed into stitches in the warp or machine direction, and other yarns 41 of a same or different strength as yarns 42 are inserted through the warp stitches, in the weft or cross direction, to provide a fabric having the same or differing tensile strengths in the machine or cross directions. In some embodiments, warp-knit weft-insertion fabric 45 has a weight of less than about 50 grams per square meter, about 10-25 grams per square meter, about 18 grams per square meter, or as low as 5 grams per square meter. The tensile strength of warp-knit weft-insertion fabrics is related to the yarn denier as well as yarn pick count or density, and can be, e.g., about 12-13 lb/in in the warp direction. An example warp-knit weft-insertion fabric 45 has a weight of between 10-25 grams per square meter, and a warp/weft yarn pick count of about 18×12 to about 9×12. The knitted warp yarns are about 40 denier polyester, and the about 150 denier fill or weft yarns are loose, nontwisted, texturized polyester filaments. In one embodiment, the warp yarns 42 have a denier of about 30 and a density of about 18 yarns/inch, and the weft yarns 41 have a denier of about 70 and a density of about 12 yarns/inch. Suitable warp-knit weft-insertion fabrics are commercially available, e.g., from Milliken & Company of Spartenburg, S.C. Further features contributing to the tearability of open fabrics are discussed in U.S. patent application Ser. No. 11/204,736, entitled “Air Permeable Pressure-Sensitive Adhesive Tapes,” the entire contents of which are hereby incorporated herein by reference in their entirety.

The characteristics of the article can be further modified by adding additional materials, such as fabrics. For example, in one embodiment, the backing includes a warp-knit weft-insertion or woven scrim fabric that is laminated to the non-woven fabric of the backing, to form a substantially non-elastic article. The warp-knit weft-insertion or woven scrim fabric can be high strength and low stretch, giving the article a substantially non-elastic character. Or, for example, in another embodiment, the article includes an elastic layer, which gives the article an elastic character.

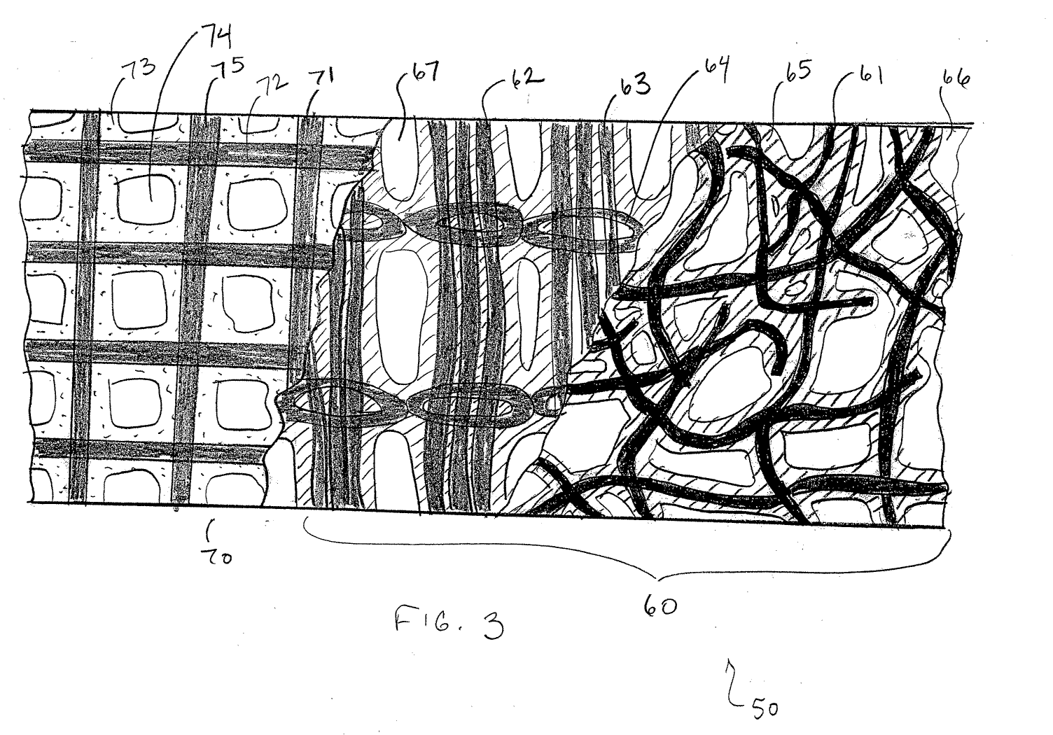

FIG. 3 illustrates a plan view of a non-elastic pressure-sensitive adhesive article with a “non-stick” backing, according to certain embodiments. Article 50 includes backing 60 and adhesive layer 70 that is applied to, e.g., bonded to or laminated to, and coextensive with backing 60. Backing 60 includes non-woven fabric 61 and warp-knit weft-insertion fabric 62, both of which carry binder 65. Warp-knit weft-insertion fabric 62 includes weft yarns 63 and warp yarns 64. Binder 65 substantially coats the outer surfaces of non-woven fabric 61 and warp-knit weft-insertion fabric 62 and, in some embodiments, laminates or bonds non-woven fabric 61 to warp-knit weft-insertion fabric 62 to form a substantially non-elastic backing 60. Binder 65 does not necessarily fill all of the pores of non-woven fabric 61 and/or warp-knit weft-insertion fabric 62, leaving open spaces 66 and 67 in the layers respectively. Adhesive layer 70 is substantially as described above, having a woven scrim fabric 71 with warp yarns 72 and weft yarns 75, adhesive 73, and open spaces 74. It should be noted that portions of adhesive layer 70 would normally be visible through the open spaces of warp-knit weft-insertion fabric 62, and portions of warp-knit weft-insertion fabric 62 would normally be visible through the open spaces of non-woven fabric 61, but these portions have been omitted in this figure for clarity of illustration.

The particular characteristics of warp-knit weft-insertion fabric 62 are selected to make backing 60, and therefore article 50, substantially non-elastic. The resulting extensibility of article 50 is thus relatively small, for example, by less than about 2%, less than about 1%, or even less than about 0.5%, during normal use, when wet, and/or until failure in a standard failure test, which is described in greater detail below.

Non-woven fabric 61 overlays warp-knit weft-insertion fabric 62, and warp-knit weft-insertion fabric 62 overlays adhesive layer 70. In other words, warp-knit weft-insertion fabric 62 is positioned between non-woven fabric 61 and adhesive layer 70. However, the ordering of the layers could be different. For example, warp-knit weft-insertion fabric 62 could be the top layer of article 50, overlaying non-woven fabric 61, with non-woven fabric 61 overlaying adhesive layer 70. Here, non-woven fabric 61 would be between warp-knit weft-insertion fabric 62 and adhesive layer 70. The selection of the ordering of the layers depends, among other things, on the desired appearance and texture of backing 60.

Backing 60 is illustrated as including a warp-knit weft-insertion fabric 62, but a woven scrim could be included instead. Both warp-knit weft-insertion and woven scrim fabrics can provide sufficient strength and non-elasticity to the backing, in addition to providing desired tear characteristics as described in greater detail above. In some embodiments, the binder substantially locks the fibers of the warp-knit weft-insertion or woven scrim fabric, so that the article can be more easily torn by hand, typically in the cross direction transverse to the orientation of the article. The material from which the warp-knit weft-insertion or woven scrim fabric is made also influences its strength and non-elastic characteristic; polyester is an example of a satisfactory material for use in some embodiments of a non-elastic article. The warp-knit weft-insertion or woven scrim fabric can have characteristics similar to that of the warp-knit weft-insertion and woven scrim fabrics described above, e.g., a weight of 18 g/m².

Additionally, adhesive layer 70 is illustrated as including a woven scrim fabric 71, but a warp-knit weft-insertion fabric or non-woven fabric could be included instead. For example, article 50 could include a backing 60 having a non-woven fabric and a woven scrim fabric, and an adhesive layer 70 having a second woven scrim fabric. Or, for example, article 50 could include a backing 60 having a non-woven fabric and a warp-knit weft-insertion fabric, and an adhesive layer 70 having a second non-woven fabric. In other words, there are many variations on the combinations of fabrics that can be included in backing 60 and adhesive layer 70. Various embodiments of adhesives, binders, warp-knit weft-insertion and woven scrim fabrics, and non-woven fabrics that are suitable for use in article 50 are described in detail above.

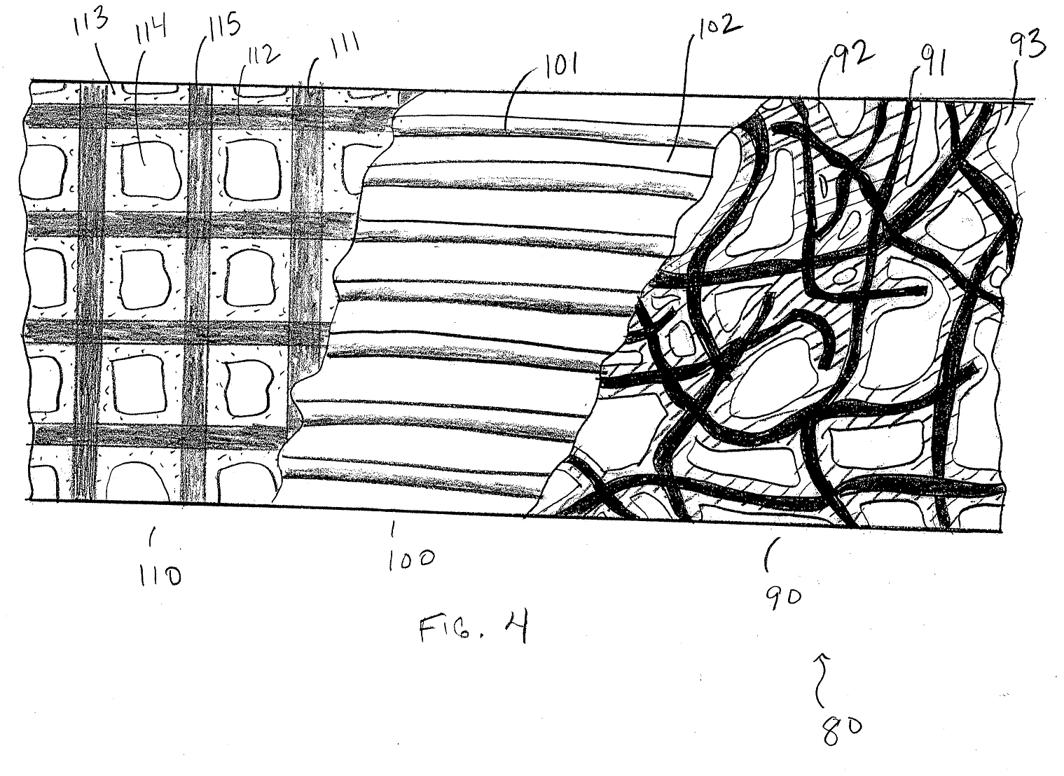

FIG. 4 illustrates a plan view of an elastic pressure-sensitive adhesive article with a “non-stick” backing, according to certain embodiments. Article 80 includes backing 90, elastic layer 100, and adhesive layer 110. Backing 90 includes non-woven fabric 91, which carries binder 92. Binder 92 substantially coats the outer surfaces of non-woven fabric 91, but does not necessarily fill all the pores of non-woven fabric 91, leaving open spaces 93. Adhesive layer 110 is substantially as described above, having a woven scrim fabric 111 with warp yarns 112 and weft yarns 115, adhesive 113, and open spaces 114. In some embodiments, elastic layer 100 includes individual elastic strands 101 spaced transversely of the article relative to each other, separated from each other with open spaces 102, and extending longitudinally of the article, as illustrated in FIG. 4. It should be noted that portions of adhesive layer 110 would normally be visible through open spaces 102 of elastic layer 100, and portions of elastic layer 100 would normally be visible through open spaces 93 of non-woven fabric 91, but these portions have been omitted in this figure for clarity of illustration.

The orientation of elastic strands 101 relative to article 80 substantially determines the direction in which article 80 is elastically extensible. In the illustrated embodiment, article 80 is elastic in a direction longitudinally of the article, i.e., in the machine direction. Backing 90 and adhesive layer 110 are substantially coextensive with each other, and are bonded or laminated to each other through open spaces 102 of elastic layer 100. This bonding effectively laminates or fixes elastic strands 101 of elastic layer 100 in place, so that they do not shift substantially during normal use. In general, elastic layer 100 could also be positioned so that it overlies backing 90, such that backing 90 was between elastic layer 100 and adhesive layer 110. In this case, however, elastic layer 100 would have to be laminated to backing 90 either using binder 92 or a separately applied adherent.

The material used for elastic strands 101 can be selected from any suitable materials, many of which are well known in the art. For example, elastic strands 101 can include one or more of Lycra, spandex, polyester, natural rubber, polyisoprene, polybutadiene, diene-styrene copolymer, diene-acrylonitrile copolymer, polychloroprene, elastomeric ethylenepropylene copolymer, styrene-butadiene block copolymer, styrene-isoprene block copolymer, elastic polyurethane yarn, polyether type urethane, and polyester type urethane. This list is not intended to be inclusive of all materials that can be used in elastic layer 100. Useful spandex threads are commercially available from Hyosung Corporation, Rock Hill, S.C., as well as from Radici Spandex, Gastonia, N.C. In some embodiments, relatively high denier elastic threads are used, having a denier of, for example, 240. Some useful deniers fall in the range of about 140 to 540 denier. In some embodiments, the elastic threads have a relatively low pick count, e.g., on the order of 10-12 threads/inch, although more or fewer threads can be used to form a suitably extensile article.

Elastic layer 100 imparts a longitudinal elasticity to article 80. The resulting extensibility of article 80 depends on the extensibility of elastic layer 100, as well as on the weight of the other materials in article 80. For example, if non-woven fabric 91 of backing layer 90 is inherently substantially non-extensible, then article 80 will also be substantially non-extensible even though it contains elastic layer 100. Thus, non-woven fabric 91 and woven scrim 111 are selected to provide sufficient strength and tearability to article 80, but also to allow article 80 to stretch according to the properties of elastic layer 100. As described in greater detail below, certain methods of making article 80 can also enhance its extensibility. In some embodiments, article 80 is extensible by 10%, or 20%, or more during normal use. In some embodiments, article 80 is extensible by 100% or more during normal use and/or during a standard extensibility test, which is described in greater detail below.

Note that binder 92 may be selected differently than it would for a non-elastic embodiment. In some instances, the presence of elastic layer 100 alters the release properties of backing 90 and/or the adhesive properties of adhesive layer 110. Because of this, certain formulations of binder 92 can result in an adhesive article that, if wound into a roll, will not unwind easily enough to be conveniently usable. In this case, binder 92 can be selected to provide the proper balance of: release from an overlying adhesive layer in the roll so that it does not require undue force to unroll the rolled article; light adhesion to an overlying adhesive layer in the roll so that the roll does not inadvertently unwind until it is used; and adhesion to adhesive layer 110 so that backing 90 does not separate from adhesive layer 110 during unroll or during normal use. One embodiment of a useful binder 92 includes a mixture of polychloroprene and styrene-butadiene copolymer, e.g., a mixture of Dispercoll® C-74 and Rovene® 4150. For example, binder 92 can include about 51 weight % of Dispercoll® C-74 and about 42 weight % of Rovene®14150, in addition to appropriate amounts of whitener, e.g., D-583, and antioxidant, e.g., Bostex-537. Sometimes binder formulations appropriate for use in an elastic pressure-sensitive adhesive article are referred to as a “sizer,” referring to the adjustment of the formulation to the elastic nature of the article.

Adhesive layer 110 is illustrated as including a woven scrim fabric 111, but a warp-knit weft-insertion fabric or non-woven fabric could be used instead. Various embodiments of adhesives, binders, warp-knit weft insertion and woven scrim fabrics, and non-woven fabrics that are suitable for use in article 80 are described in detail above.

It should be noted that not all of the embodiments described herein are necessarily porous. For example, the backing of the described articles can include a substantially non-porous non-woven fabric, such as a high weight non-woven fabric, instead of a porous fabric.

Methods and Equipment for Making Pressure-Sensitive Adhesive Articles with “Non-Stick” Backings

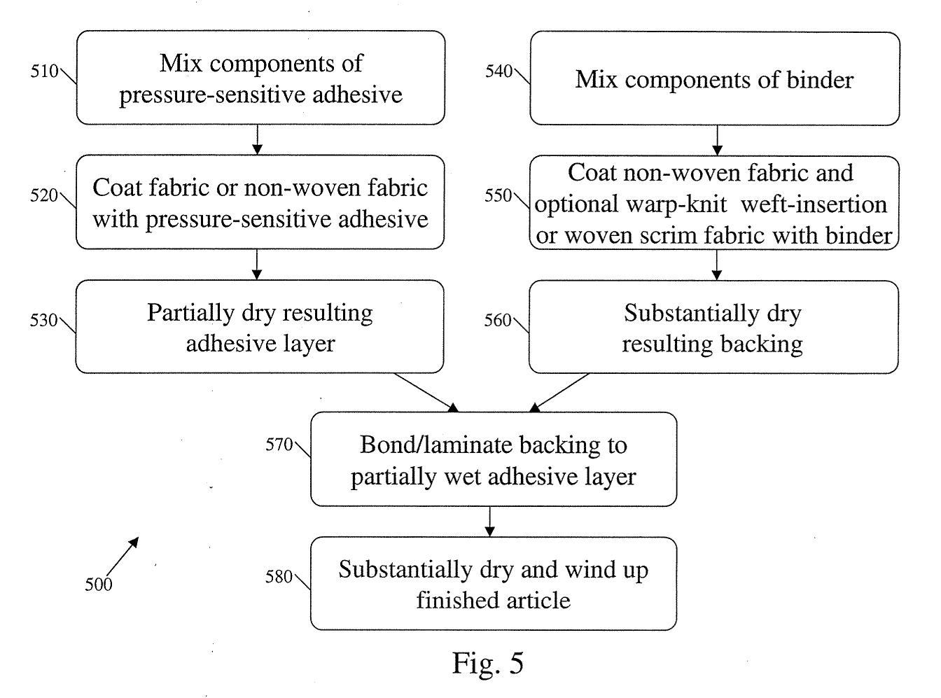

In some embodiments, the backing and adhesive layers are fabricated separately and then bonded to each other to form a finished adhesive article. FIG. 5 is a flow chart of one method (500) for making an (optionally non-elastic) pressure-sensitive adhesive article according to one or more embodiments. In one part of the method, the pressure-sensitive adhesive is prepared by mixing its various components together (510). In some embodiments, each component is aqueous, or water soluble, and thus easily mixed in a suitable mixer. Then, the adhesive layer is fabricated by coating the fabric or non-woven fabric of the adhesive layer with the pressure-sensitive adhesive (520). The pressure-sensitive adhesive substantially saturates the fabric or non-woven fabric. In some embodiments, the resulting adhesive is then only partially dried (530).

In another part of the method, either before, concurrently, or after the fabrication of the adhesive layer, the binder is prepared by mixing its various components together (540). In some embodiments, each component is aqueous, or water soluble, and thus easily mixed in a suitable mixer. Then, the backing is fabricated by coating the non-woven fabric of the backing with the binder (550). Optionally, a warp-knit weft-insertion or woven scrim fabric is also coated with the binder, resulting in a non-elastic backing. The binder substantially saturates the non-woven fabric and the optional warp-knit weft-insertion or woven scrim fabric. The resulting backing is typically substantially dried after this step (560).

When both the adhesive layer and backing are prepared and at a desired level of dryness, they are laminated or bonded together (570). In some embodiments, this bonding or lamination typically includes contacting the adhesive layer to the backing when the adhesive layer is partially wet, so that the adhesive partially penetrates into the backing, e.g., into the open spaces of the backing, to form a strong and secure bond. This bonding or lamination does not necessarily require the use of heat to bond the two layers together. The finished article is then substantially dried and wound on a reel (580).

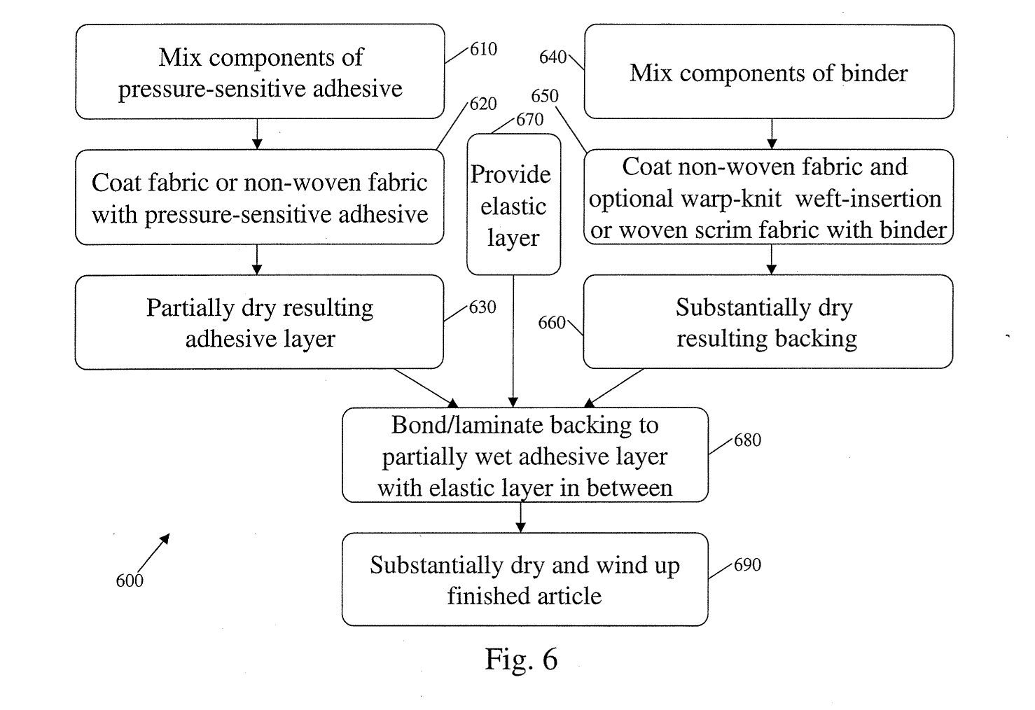

FIG. 6 is a flow chart of a method (600) of making an elastic pressure-sensitive adhesive article according to one or more embodiments. A pressure-sensitive adhesive layer is prepared substantially as described above, having steps of: preparing the adhesive (610), coating a fabric or non-woven fabric with the adhesive (620), and partially drying the resulting adhesive layer (630). A backing is prepared by first preparing the binder, by mixing its various components together (640). In some embodiments, each component is aqueous, or water soluble, and thus easily mixed in a suitable mixer. Then, the backing is fabricated by coating, and substantially saturating, the non-woven fabric of the backing with the binder (650). The resulting backing is typically substantially dried after this step (660).

Additionally, an elastic layer is provided (670), e.g., a number of individual elastic yarns spaced transversely of the article relative to each other and extending substantially longitudinally to the article. When both the adhesive layer and backing are prepared and at a desired level of dryness, they are laminated or bonded together, with the elastic layer positioned between them (680). In some embodiments, this bonding or lamination typically includes contacting the adhesive layer to the backing when the adhesive layer is partially wet, so that the adhesive partially penetrates into the backing, e.g., into the open spaces of the backing, to form a strong and secure bond. This bonding or lamination does not necessarily require the use of heat to bond the two layers together. The adhesive layer partially contacts the backing through open spaces in the elastic layer, allowing for a strong and secure bond between the backing and adhesive layer. Additionally, this secure bond substantially fixes the elastic layer in place, so that the yarns do not shift when the article is used. The finished article is then substantially dried and wound on a reel (690).

In general, other kinds layers can be included in an article as described above, typically by inserting them between the backing and pressure sensitive adhesive layer and bonding or laminating the assembly together. In some embodiments, these layers will have open spaces through which the backing and adhesive layer can securely bond to each other, so that no additional kind of adhesive or laminating agent will be needed to form a usable, securely laminated article.

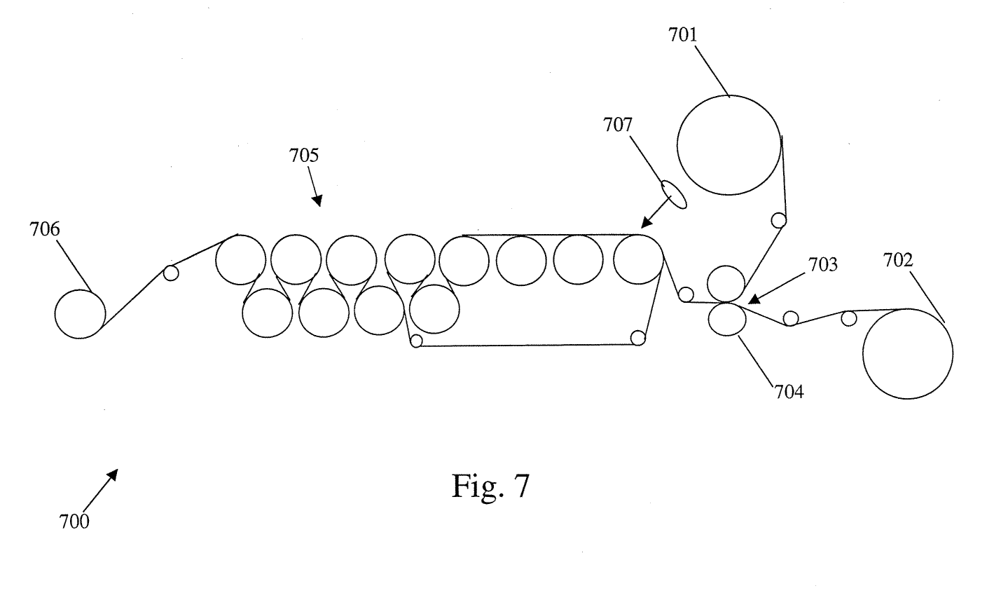

FIG. 7 shows an apparatus 700 on which a backing can be made according to the method in the flow-chart of FIG. 5, i.e., an optionally non-elastic backing. Apparatus 700 includes a non-woven fabric reel 701, an optional warp-knit weft-insertion or woven scrim fabric reel 702, a dispenser 703 (not explicitly illustrated) for coating binder onto the non-woven fabric and optional warp-knit weft-insertion or woven scrim fabric, an adjustable nip 704 for squeezing excess binder from the binder-coated non-woven fabric and optional warp-knit weft-insertion or woven scrim fabric, a series of heated drying cans 705 for substantially drying the resulting backing, and a windup reel 706 for collecting the resulting backing.

The non-woven fabric reel 701 and optional warp-knit weft-insertion or woven scrim fabric reel 702 are typically purchased from a commercial vendor and inserted into apparatus 700 as received. The reels 701, 702 are typically wound at a particular tension, and so when they are unwound their tensions can be adjusted within apparatus 700 to provide the desired tension during fabrication of the backing. The apparatus 700 guides the non-woven fabric and optional warp-knit weft-insertion or woven scrim fabric so they are adjacent and then coats them with binder (which is prepared separately) at dispenser 703. Dispensers for binders and similar liquids are known in the art. In some embodiments, dispenser 703 coats the binder only onto the non-woven fabric, or onto the optional warp-knit weft-insertion or woven scrim fabric. Then, when the fabrics are contacted together, the binder spreads onto both.

Then, the binder-coated non-woven fabric and optional warp-knit weft-insertion or woven scrim fabric are squeezed through adjustable nip 704. The spacing of adjustable nip 704 can be changed so as to squeeze a desired amount of binder out of the coated non-woven fabric and optional warp-knit weft-insertion or woven scrim fabric, to provide a desired co-weight of binder. The desired co-weight of binder depends on the particular characteristics of the binder, the pressure-sensitive adhesive, and the desired characteristics of the finished article. Adjustable nip 704 also helps to evenly coat and saturate the non-woven fabric and optional warp-knit weft-insertion or woven scrim fabric with the binder.

Next, the binder-coated non-woven fabric and optional warp-knit weft-insertion or woven scrim fabric, i.e., the resulting backing, is fed onto a series of heated drying cans 705. The drying cans 705 are heated to a suitable temperature to substantially dry the backing as it passes over the cans, e.g., to a temperature of about 270° F. for some embodiments of water-based binders. Heated drying cans 705 are typically coated so that the backing does not adhere to the cans. Silicone-coated nylon wrapping is an example of a suitable coating for at least some of the backings described herein. Additionally, a fan 707 helps to dry the backing. Lastly, the backing is wound onto windup reel 706 at a desired tension.

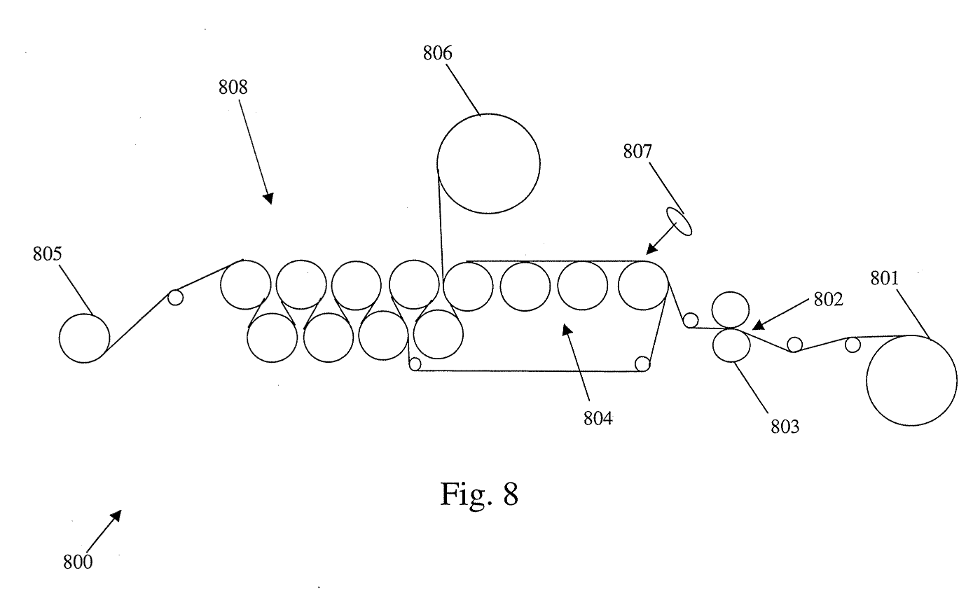

FIG. 8 shows an apparatus 800 for fabricating a finished optionally non-elastic pressure-sensitive adhesive article with “non-stick” backing, according to the method in the flow-chart of FIG. 5. Apparatus 800 includes a fabric or non-woven fabric reel 801, a dispenser 802 (not explicitly illustrated) for coating pressure-sensitive adhesive onto the fabric or non-woven fabric, an adjustable nip 803 for squeezing excess adhesive from the adhesive-coated fabric or non-woven fabric, a series of drying cans 804 for partially drying the resulting adhesive layer, a backing reel 806, a series of drying cans 808 for substantially drying the article (the adhesive layer bonded to the backing), and a windup reel 805 for collecting the resulting finished article.

The fabric or non-woven fabric reel 801 is typically purchased from a commercial vendor and inserted into apparatus 800 as received. The reel 801 is typically wound at a particular tension, and so when it is unwound its tension can be adjusted within apparatus 800 to provide the desired tension during fabrication of the adhesive layer. Apparatus 800 then coats fabric or non-woven fabric with adhesive (which is prepared separately) at dispenser 802. Then, the adhesive-coated fabric or non-woven fabric is squeezed through adjustable nip 803. The spacing of adjustable nip 803 can be changed so as to squeeze a desired amount of adhesive out of the coated fabric or non-woven fabric, to provide a desired co-weight of adhesive. The desired co-weight of adhesive depends on the particular characteristics of the pressure-sensitive adhesive, the binder, and the desired characteristics of the finished article. Adjustable nip 803 also helps to evenly coat and saturate the fabric or non-woven fabric with the adhesive.

Next, the adhesive-coated fabric or non-woven fabric, i.e., the resulting adhesive layer, is fed onto a series of heated drying cans 804, which are substantially the same as those described above, e.g., heated to a suitable temperature and having a suitably non-adherent coating. A fan 807 helps to dry the adhesive layer. However, the adhesive layer is typically not dried completely on cans 804, but is deliberately left partially wet. The wetness of the adhesive layer is selected so that layer bonds satisfactorily to the backing, but so that the finished article does not take too long to dry.

Then, a backing reel 806 feeds a backing (fabricated, e.g., as described above) from backing reel so that it contacts and is bonded or laminated to the adhesive layer. The backing can either be oriented so that the optional warp-knit weft-insertion or woven scrim fabric of the backing is adjacent to the adhesive layer, or so that the non-woven fabric of the backing is adjacent to the adhesive layer. The orientation selected will depend on the desired appearance and texture of the finished article. The resulting article is then fed onto another series of heated drying cans 807, which are substantially the same as those described above, e.g., heated to a suitable temperature and having a suitably non-adherent coating. The article substantially dries on this series of cans. Lastly, the resulting article is wound onto a windup reel 805 at a desired tension.

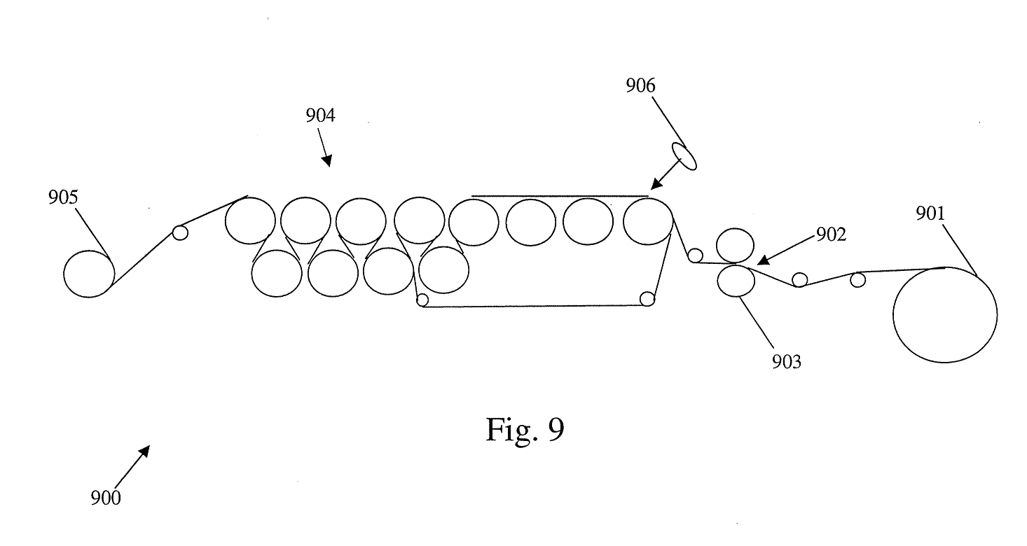

FIG. 9 shows an apparatus 900 on which a backing can be made according to the method in the flow-chart of FIG. 6, i.e., a backing suitable for an elastic article. Apparatus 900 includes a non-woven fabric reel 901, a dispenser 902 (not explicitly illustrated) for coating binder onto the non-woven fabric, an adjustable nip 903 for squeezing excess binder from the binder-coated non-woven fabric, a series of heated drying cans 904 for substantially drying the resulting backing, a fan 906 for helping dry the backing, and a windup reel 905 for collecting the resulting backing. These components are all substantially the same, and operate similarly, as those described for FIG. 7; the main difference between apparatus 900 and apparatus 700 is that no optional warp-knit weft-insertion fabric reel is included. Eliminating optional warp-knit weft-insertion or woven scrim fabric allows for a more stretchable backing that is suitable for use with an elastic layer to form an elastic pressure-sensitive adhesive article with “non-stick” backing. In some embodiments, the binder is formulated to be suitable for use in an elastic article, as is described in greater detail above.

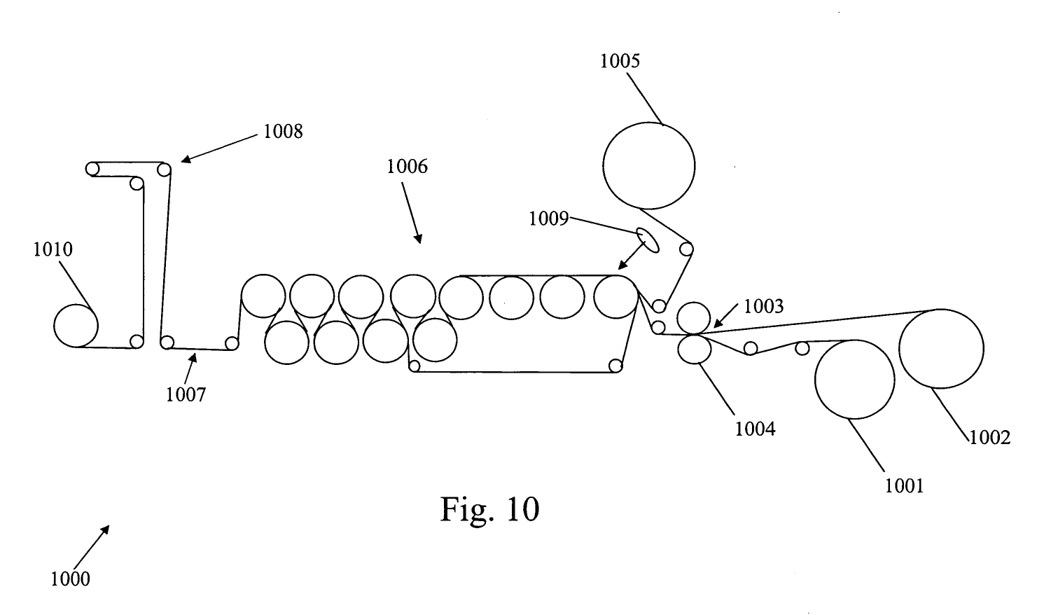

FIG. 10 shows an apparatus 1000 for fabricating a finished elastic pressure-sensitive adhesive article with “non-stick” backing, according to the method in the flow-chart of FIG. 6. Apparatus 1000 includes a fabric or non-woven fabric reel 1001, an elastic layer reel 1002, a dispenser 1003 (not explicitly illustrated) for coating pressure-sensitive adhesive onto the fabric or non-woven fabric and adhesive layer, an adjustable nip 1004 for squeezing excess adhesive from the adhesive layer, i.e., the adhesive-coated fabric or non-woven fabric and elastic layer, a backing reel 1005, a series of drying cans 1006 for substantially drying the article (the adhesive layer bonded to the backing), a steam applier 1007, an adjustable drying apparatus 1008, and a windup reel 1010 for collecting the resulting finished article.

The fabric or non-woven fabric reel 1001 is substantially the same as described above. The elastic layer reel 1002 is typically purchased from a commercial vendor and inserted into apparatus 1000 as received. The reel 1002 is typically wound at a particular tension, and so when it is unwound its tension can be adjusted within apparatus 1000 to provide the desired tension during fabrication of the adhesive layer. The extensibility of the finished article is sensitive to this tension, as well as to the tension of the other layers in the article, so these tensions are carefully selected depending on the desired performance of the finished article. Apparatus 1000 then coats the fabric or non-woven fabric and the elastic layer with adhesive (which is prepared separately) at dispenser 1003. Then, the adhesive-coated fabric or non-woven fabric and adhesive layer is squeezed through adjustable nip 1004, which is substantially the same as described above.

Next, the adhesive-coated fabric or non-woven fabric and elastic layer, i.e., the resulting adhesive layer, is brought into contact with the backing (fabricated, e.g., as described above), fed off of backing reel 1005 from backing reel. The backing contacts and is bonded or laminated to the adhesive layer, such the elastic layer is between the backing and the fabric or non-woven fabric of the adhesive layer. The resulting article is then fed onto a series of heated drying cans 1006, which are substantially the same as those described above, e.g., heated to a suitable temperature and having a suitably non-adherent coating. A fan 1009 helps to dry the resulting article, which is kept under a specified tension as it dries. This tension partially determines the extensibility of the finished article. The article substantially dries on drying cans 1006. Then, the tension on the article is released, and the article is treated with steam applier 1007 (not explicitly illustrated). The amount of applied steam can be adjusted to partially relax the elastic layer by a desired amount, so as to controllably modify the extensibility of the finished article. Then, the article is fed through adjustable drying apparatus 1008 at a desired tension, which can be adjusted to also controllably adjust the extensibility of the finished article. Lastly, the resulting article is wound onto a windup reel 1010 at a desired tension.

The various fabrics, non-woven fabrics, binders, adhesives, and elastic layer can be selected and prepared as described in greater detail herein.

Methods and Equipment for Characterizing Pressure-Sensitive Adhesive Articles

The overall extensibility of a finished, elastic adhesive article can be characterized using a standard extensibility test. In one standard extensibility test, about a 10 cm×30 cm piece of the article is provided. About 5 pounds of force are applied to one of the 10 cm edges of the piece of the article, longitudinally stretching the article from its normal resting position. The percent by which the piece of the article stretches is called the extensibility of the article. Typically, the article will also stretch by about this much during normal use, e.g., when used to support a joint. As mentioned above, certain embodiments of elastic pressure-sensitive adhesive articles with “non-stick” backings can be extensible by more than about 10%, 20%, or even more than about 100% both in a standard extensibility test and during normal use.

The unwind adhesion (overlap adhesion), or the force required to unwind or unroll a rolled pressure-sensitive adhesive article, can be quantified with standard test methods, such as ASTM D 1000 “Standard Test Methods for Pressure-Sensitive Adhesive-Coated Tapes Used for Electrical and Electronic Applications,” ASTM International; Afera 4008, “Measurement of the Unwinding Force of Adhesive Tapes at High Speed,” Afera; Afera 4013, “Unwind Adhesion of Adhesive Tape at Low Speed,” Afera; PSTC-8, “Unwind Force of Pressure Sensitive Tapes,” Pressure Sensitive Tape Council; and PSTC-13, “High Speed Unwind Adhesion of Pressure Sensitive Tapes,” Pressure Sensitive Tape Council, the entire contents of which are hereby incorporated herein by reference. In one standard test method, a rolled article, of about 6 to 50 mm width and at least 50 m length, is conditioned for at least 24 hours in a standard atmosphere before testing. Then, the force required to unwind the rolled article is measured by mounting it on a substantially friction-free axis, in an unwinding machine. The unwinding machine then unwinds the rolled article at a constant speed, typically between about 15 to 120 meters/minute; a feedback loop on the machine holds the unwind speed constant. The unwinding machine measures the force required to obtain this speed every 15 seconds, for at least 3 measurements, but does not measure the first few, e.g., the first three, turns of the roll. The machine typically measures the force to obtain the desired unwind speed, and takes the average of the measurements over the length of the rolled article as it is unwound. The unwinding force is then expressed as a function of the width of the article, typically in Newton/cm-width, or in ounces/inch-width. The HSU-1000 High Speed Unwind Machine and the TT-1000 Tensile Tester, available from Cheminstruments, Inc., Fairfield, Ohio, are examples of instruments on which one or more of the incorporated unwind force standard test methods can be performed.

An adhesive article with a “non-stick” backing such as those described herein can be wound upon itself to form overlying layers under standard test conditions, and the unwind force to unroll the rolled article measured. Some embodiments of such rolled adhesive articles are unrolled with an unwinding force of about 20 ounces/inch-width in a standard unwind force test. Note that the unwind force for a rolled article is a function not only of the materials used in the backing and the adhesive layer, but also of the force with which the article was rolled or wound upon itself. This force is sometimes called the “Rewind Tension” (RT). This refers to the fact that frequently, in the fabrication of pressure-sensitive adhesive articles, a very wide and long batch of the article is fabricated and wound onto a large reel. This batch is then subsequently unwound, slit into several smaller tapes or articles, e.g., of about 1″ width and 15 yards length, and rewound onto small reels for packaging and sale. These smaller tapes are normally rewound at a specific tension, i.e., a specific rewind tension (RT). The specific tension at which the tape is wound affects how easily it is later unwound.

Thus, the standard test conditions can include winding or rolling the article with a particular force, or rewind tension, e.g., of 25 ounces/inch-width or less, before measuring the unwind force. Or, the standard test conditions can include winding or rolling the article with a force, or rewind tension, of 28 ounces/inch-width, or even 35 ounces/inch-width or more, before measuring the unwind force. Typically, the unwind force of a rolled article such as those described herein, and particularly a rolled article suitable for commercial use, is sufficiently low that the article can be unwound without undue force, e.g., with hand force.

The peel adhesion (peel strength or peel force) of a pressure-sensitive adhesive article is a measure of the adherence of the article to a surface when peeled from that surface at an angle, e.g., at a 90° or 180° angle. The peel adhesion is relevant not only to how easily the article can be peeled from a surface during use, but also to how easily the article unrolls if it is wound into a roll. The peel adhesion of a pressure-sensitive adhesive article can be quantified with standard test methods, such as ASTM D 3330/D 3330M-04 “Standard Test Method for Peel Adhesion of Pressure-Sensitive Tape,” ASTM International; and PSTC-101 “International Standard for Peel Adhesion of Pressure Sensitive Tape,” Pressure Sensitive Tape Council, the entire contents of which are hereby incorporated herein by reference. In one standard test method, a roll of the article is conditioned for at least 24 hours in a standard atmosphere before testing. Then, a standard surface, e.g., the surface of a standard stainless steel panel, is cleaned with solvents, and a piece of the article measuring about 24 mm in width and 300 mm in length is unrolled at a fixed rate from the roll, typically between about 500 to 750 mm/second. About 12 mm at one end of the article is folded upon itself, to form a tab. Then, within 5 minutes of unrolling the article, it is applied to the surface by first touching the non-tab end of the article to the surface, and then, starting from that end, using a standard roller to mechanically press the remainder of the article onto the surface. The standard roller can be about 4.5 pounds, or about 5 pounds, and is used to roll the article on the surface a fixed number of times, typically from about 2-5 times. This method substantially prevents the entrapment of air between the article and the surface.

Next, the tab end of the article is doubled back at an angle of about 180° and peeled for about 25 mm from the surface. The tab is clamped into a jaw of an adhesion-testing machine, and the edge of the panel opposing the tab is clamped into a second, movable jaw of the machine. The adhesion-testing machine moves the movable jaw at a rate of about 5.0 mm/second and measures the average force required to peel the article from the surface. The force require to peel about the first inch of the article from the surface is not measured. This procedure is repeated several times, and for pieces of article taken from multiple rolls. Typically, the first few turns, e.g., the first three turns, of each roll are not tested. The peel adhesion (peel strength) is then expressed as a function of the width of the article, typically in Newton/cm-width, or in oz/inch-width. The TT-1000 Tensile Tester, available from Cheminstruments, Inc., Fairfield, Ohio is an example of an instrument on which one or more of the incorporated peel adhesion standard test methods can be performed.

The shear adhesion (shear strength or shear force) of a pressure-sensitive adhesive article is a measure of the ability of the article to remain adhered to a surface under a constant load, which is applied parallel to the article. The shear adhesion of an article is also related to how easily the article unrolls, if it is wound into a roll. The shear adhesion of a pressure-sensitive adhesive article can be quantified with standard test methods, such as ASTM D 3654/D3654M-02 “Standard Test Methods for Shear Adhesion of Pressure-Sensitive Tapes,” ASTM International; or PSTC-107 “International Standard for Shear Adhesion of Pressure Sensitive Tape,” Pressure Sensitive Tape Council, the entire contents of which are hereby incorporated herein by reference. In one standard test method, a roll of the article is conditioned for at least 24 hours in a standard atmosphere before testing. Then, a standard surface, e.g., the surface of a standard stainless steel panel, is cleaned with solvents, a piece of the article measuring about 12 mm in width and 150 mm in length is unrolled at a fixed rate from the roll, typically between about 500 to 750 mm/second. Then, within 5 minutes of unrolling the article, it is applied to the surface by first touching one end of the article about 12 mm from an edge of the surface, so that only an area about 12 mm×12 mm of the surface is covered by the article and the rest of the article extends away from the panel, into free space. Then, where the article touches the surface, a standard roller is used to mechanically press the remainder of the article onto the surface. The standard roller can be about 4.5 pounds, or about 5 pounds, and is used to roll the article on the surface a fixed number of times, typically from about 2-5 times. This method substantially prevents the entrapment of air between the article and the surface.

Next, the panel is placed in a test stand that will support the panel in a vertical plane, at an angle of about 0-2° with respect to vertical. The free end of the article is adhered to a hook or clamp attached to a standard mass, e.g., a 1000-gram weight, so that the mass will securely hang from the free end of the article. The mass is gently released, so as to cause no shear impact force on the article, and the time it takes for the article to release from the surface is measured. Alternately, various masses can be attached to the free end, and the mass required to cause the article to release from the surface is determined. The measurement is repeated several times, and for pieces of article taken from multiple rolls. Typically, the first few turns, e.g., the first three turns, of each roll are not tested. If a variety of weights are used to determine the shear adhesion of the article, then the shear adhesion (shear strength) is then expressed as a function of the area of the article, e.g., in pounds/m²; or if a single standard weight is used to determine the shear adhesion of the article, the shear adhesion (shear strength) is then expressed as a function of the time required for the article to release from a surface, e.g., in minutes. The RT-10 Room Temperature 10 Bank Shear Tester, available from Cheminstruments, Inc., Fairfield Ohio, is an example of an instrument on which one or more of the incorporated shear adhesion standard test methods can be performed.

In general, the peel adhesion (also referred to as a peel force or peel strength) and shear adhesion (also referred to as a shear force or shear strength) can be measured from any surface, not just a stainless steel surface. For example, the peel and shear adhesions for a particular backing can be measured relative to a standard adhesive surface, allowing the adhesion between the backing and adhesive to be quantified. One suitable standard adhesive surface against which the adhesion of a backing can be measured is the adhesive of #150 Trainer Tape, available from Andover Coated Products, Andover, Mass.). The adhesion of a backing can also be measured relative to other adhesive surfaces, for example, again the adhesive surface of an adhesive layer such as those described herein.

Various embodiments of pressure-sensitive adhesive articles with “non-stick” backing, such as those described herein, may have a peel strength and/or shear strength and/or unwind force (overlap adhesion) sufficient to prevent the article, if wound, from unwinding without the use of sufficient force, e.g., hand force. For example, the peel strength may be about 9 ounces/inch-width, or more or less, as measured by a standard peel strength test. The test can include rolling the article 5 times or more with a standard roller, such as a 5-pound roller. Or, for example, the shear strength may be about 16 pounds/inch² as measured by a standard shear strength test. The test can include rolling the article five times or more with a standard roller, such as a 5-pound roller.

The tensile strength of a pressure-sensitive adhesive article is a measure of its inherent strength, such as its resistance to failure or damage. For example, if a tensile force elongates an article beyond a certain percentage of its length, it will be damaged and may fail. The tensile strength of a pressure-sensitive adhesive article can be quantified with standard test methods, such as ASTM D 3759/D 3759M-05 “Standard Test Method for Tensile Strength and Elongation of Pressure-Sensitive Tapes,” ASTM International; and PSTC-131 “International Tensile Strength and Elongation of Pressure Sensitive Tapes,” Pressure Sensitive Tape Council, the entire contents of which are hereby incorporated herein by reference. In one standard test method, a roll of article is conditioned for at least 24 hours in a standard atmosphere before testing. Then, opposing ends of a piece of the article measuring about 24 mm in width and 300 mm in length are clamped into respective jaws of a tensile strength tester, one of which is movable. The tensile strength tester then moves the movable jaw at a fixed rate, typically between 0.5 to 25 inches per minute, and measures the force required to move the movable jaw, as well as the resulting elongation of the article, until the article fails. The tensile strength is then expressed as a function of the width of the article, e.g., in pounds/inch-width. The TT-1000 Tensile Tester, available from Cheminstruments, Inc., Fairfield, Ohio is an example of an instrument on which one or more of the incorporated tensile strength standard test methods can be performed.

Certain embodiments of non-elastic pressure-sensitive adhesive articles with “non-stick” backings, such as those described herein, are extensible by only about 2% or less, 1% or less, or even 0.5% or less using the described method. Moreover, the extensibility of the articles does not substantially change if the article becomes wet, for example, by less than about 0.5% at a tensile force of about 5 pounds. In contrast, the extensibility of some commercially available alternatives does substantially change if the article becomes wet, for example, by more than about 0.5% at a tensile force of about 5 pounds.

### EXAMPLES

The following examples should not be construed as limiting.

### Example 1

### Non-Elastic Pressure-Sensitive Adhesive Tape

A non-elastic pressure-sensitive adhesive article [EX3042B] according to FIG. 3 was fabricated. In the backing, the binder [2033-74] includes about 87.1% Dispercoll® C-74 polychloroprene, about 1.6% Foamaster® NDW defoamer, about 10.0% D 583 whitener, about 1.0% Bostex 537 antioxidant, and about 0.4% Paragum-184 thickener. The non-woven fabric in the backing is a 10 g/m² non-woven fabric from Yongdeli (China), and the fabric in the backing is an 18×12 (40 denier×70 denier) warp-knit weft-insertion fabric from Milliken & Company (S.C.). The backing was fabricated using an apparatus such as that illustrated in FIG. 7.

In the adhesive layer, the pressure sensitive adhesive [2023-52-B] includes about 28.2% Butofan® NS166 adhesive, about 42.1% Tacolyn 5085 tackifier, about 26.0% Hartex 101 natural rubber latex, about 0.4% Foamaster® NDW defoamer, about Octowet 70PG surfactant, about 2.7% D 583 whitener, and about 0.5% Paragum-184 thickener. The fabric in the adhesive layer is an 18×12 (40 denier×70 denier) warp-knit weft-insertion fabric from Milliken & Company (S.C.). The adhesive layer was fabricated, and bonded to the backing, using an apparatus such as that illustrated in FIG. 8.

### Example 2

### Elastic Pressure-Sensitive Adhesive Tape

An elastic pressure-sensitive adhesive article according to FIG. 4 was fabricated. In the backing, the binder [2033-92-LS] includes about 50.9% Dispercoll® C-74 polychloroprene, about 43.2% Rovene® 4150 butadiene-styrene copolymer, about 5.1% D 583 whitener, and about 0.76% Bostex 537 antioxidant. The non-woven fabric in the backing is a 12 g/m² non-woven fabric from First Quality Nonwovens (NY). The backing was fabricated using an apparatus such as that illustrated in FIG. 9.

The elastic layer is 240 denier spandex threads at a pick count of about 560 yarns/inch, from Radici Spandex (N.C.). In the adhesive layer, the pressure sensitive adhesive [2023-52-B] includes about 28.2% Butofan® NS166 adhesive, about 42.1% Tacolyn 5085 tackifier, about 26.0% Hartex 101 natural rubber latex, about 0.4% Foamaster® NDW defoamer, about 0.1% Octowet 70PG surfactant, about 2.7% D 583 whitener, and about 0.5% Paragum-184 thickener. The fabric in the adhesive layer is an 18×12 (40 denier×70 denier) warp-knit weft-insertion fabric from Milliken & Company (S.C.). The adhesive layer was fabricated, and bonded to the backing and the elastic layer, using an apparatus such as that illustrated in FIG. 10.

### Example 3

### Comparison of Elastomers in Binder in Peel Force Test of Backing from Standard Adhesive Layer

In order to investigate the affect of the backing binder composition on the resulting adhesiveness of the backing to a pressure-sensitive adhesive carrying fabric layer, backings carrying various commercially available binder preparations were made and tested for their adhesiveness to a standard adhesive surface, in this case the adhesive layer of #150 Trainer Tape, in a peel force measurement. In general, binders that produce an intermediate level of adhesiveness to a pressure-sensitive adhesive layer provide the desirable properties of a sufficient, but not excessive, adhesiveness to allow ready secure adhesion of the backing to the adhesive layer when the article is wound into a finished roll of tape, while avoiding excessive adhesion of the backing to an overlying adhesive layer that would prevent facile unwinding of the tape by a user.

The non-woven fabric based backing was prepared using seven different commercially-available binders: Acronal® 3432 (a dispersion of a carboxylated acrylic polymer, available from BASF, Florham Park, N.J.); Acronal® A 310 S (an aqueous dispersion of an acrylate copolymer, available from BASF, Florham Park, N.J.); Dispercoll® C-74 (described in greater detail above); Hartex 101 (a low ammonia natural latex available from Firestone Natural Rubber Company, Akron, Ohio); Macekote 9252 available from Mace Company, Dudley, Mass.; Styrofan 4710 (a carboxylated styrene-butadiene dispersion available from BASF, Florham Park, N.J.); and Degree 100A available from SOLV Inc, Rock Hill, S.C. Four separate samples of each these backings was prepared, and the peel force required to peel the backing from the adhesive layer of #150 Trainer Tape was measured with a standard peel force measurement as described above. In addition, the cohesive binder coat weight (g/m²) of each sample was determined.

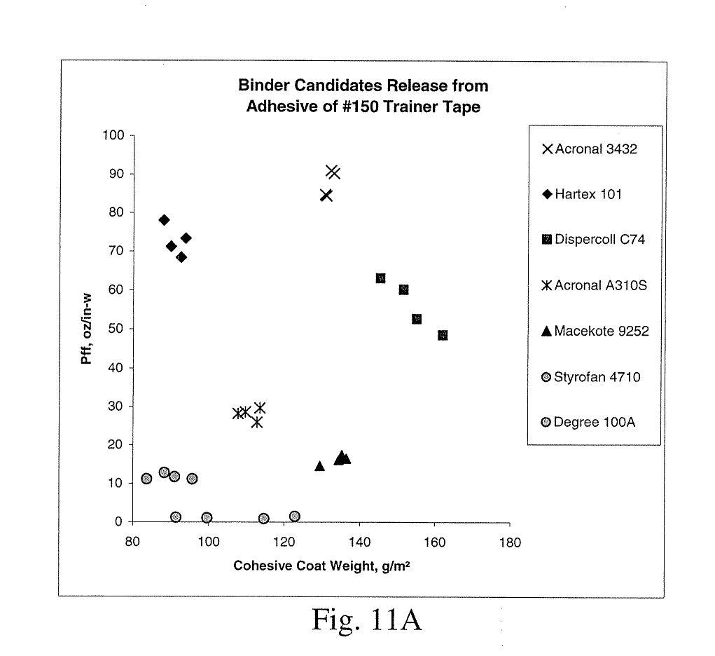

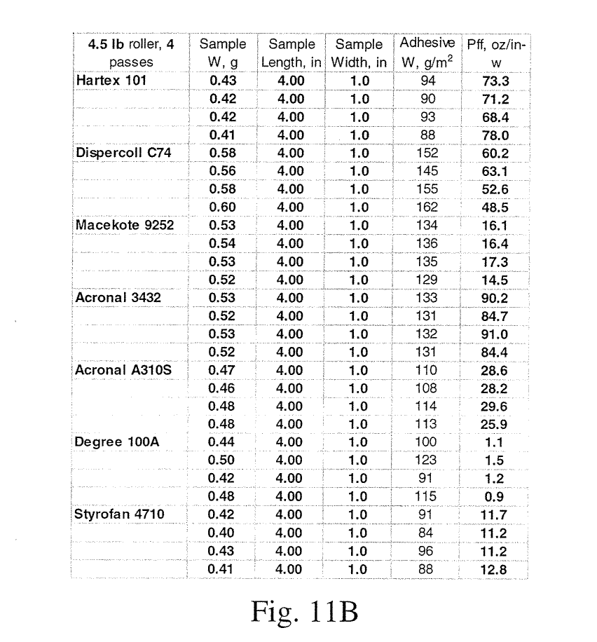

The results are summarized in the graph shown in FIG. 11A. A detailed summary of each test sample's weight, size, cohesive coat weight and peel force adhesiveness to the adhesive layer of #150 Trainer Tape is provided in the table shown in FIG. 11B. The results show that a backing made with Degree 100a binder (lighter shaded circles) was insufficiently adhesive to the pressure-sensitive adhesive layer (average of 1.2 oz/in-w), while a binder made with Styrofan® 4710 binder (darker shaded circles) had a low, but functional, level of adhesion to the pressure-sensitive adhesive layer. Backings prepared with Macekote 9252, Acronal® A310S, Dispercoll® C74, and Hartex 101 possessed a broad range of functional, intermediate levels of adhesiveness to the adhesive layer of #150 Trainer Tape in the peel force test. A backing prepared with Acronal® 3432 had a relatively high level of adhesiveness to the adhesive layer of #150 Trainer Tape, which, although functional, would require more force to unwind the roll by the user than is considered desirable.

### Example 4

### Effect of Rewind Tension on Unwind Force

In order to investigate the effect of the tension used to wind the final roll on the adhesive properties of the tape [EX 3042B] of Example 1, rolls of tape were produced at three different rewind tensions (i.e., 25 oz/in-w, 28 oz/in-w and 35 oz/in-w). The following standard test measurements were then performed on pieces taken from the resulting tape rolls: peel force (Peel FB), shear force (Shear FB), tensile strength, unwind force, and article weight.

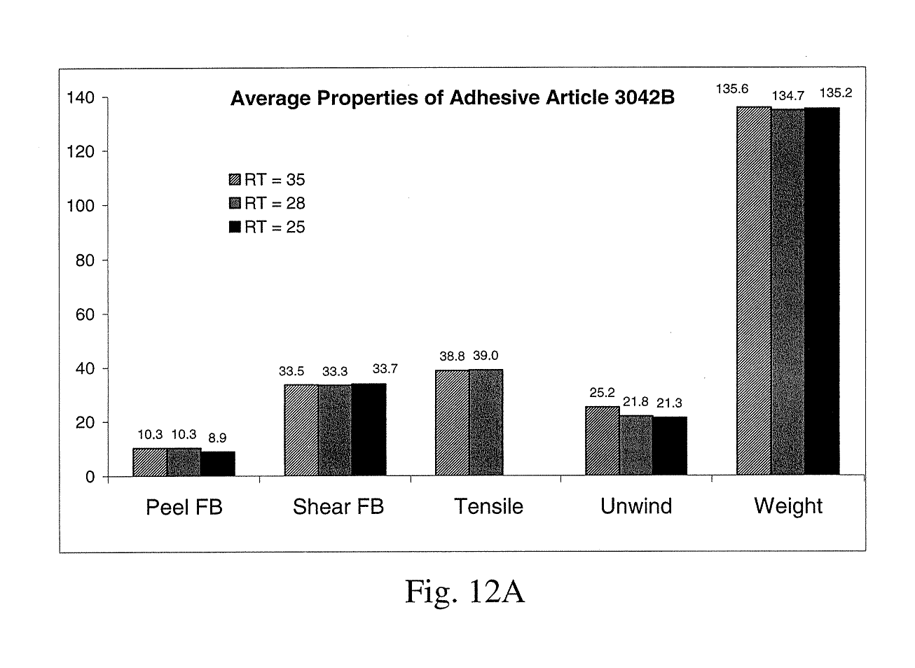

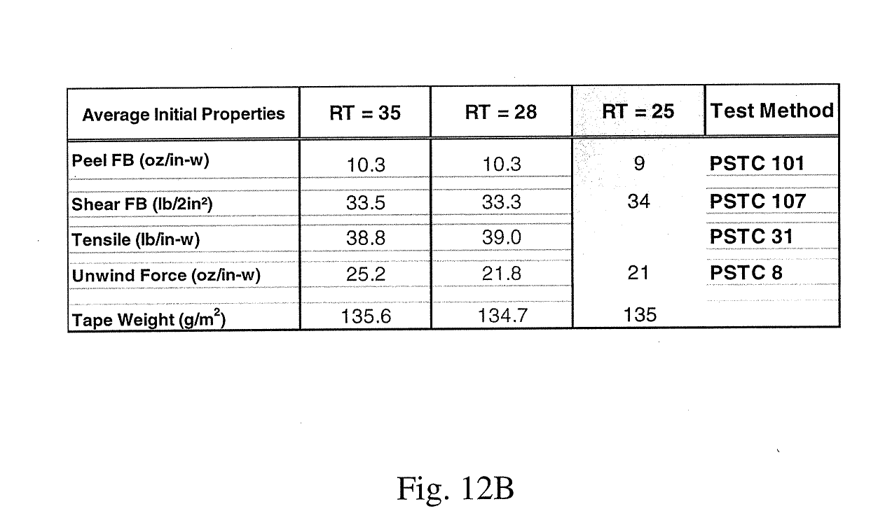

The results are shown in the graph in FIG. 12A and the data summarized in the table shown in FIG. 12B. The results indicate that all three rewind tensions produced tapes with similar weights, and similar standard peel force, shear force and tensile strengths, but with significantly different unwind force properties. In particular, rewind tensions of 25 oz/in-w or 28 oz/in-w produced optimal unwind force measurements of 21.3 oz/in-w and 21.8 oz/in-w respectively, allowing facile hand unwinding by a user. In contract, the roll produced by rewinding at a tension of 35 oz/in-w required a slightly higher than optimal, but still functional, unwind force measurement of 25.2 oz/in-w. In general it has been found that a rolled article having an unwind force between about 15 and 25 oz/in-w is low enough to unwind by hand, whereas articles with larger unwind forces, e.g., 25-35 oz/in-w are typically difficult to unwind by hand.

### Example 5

### Effect of Coat Weight on Unwind Force

In order to investigate the effect of both the amount of pressure-sensitive adhesive carried by the pressure-sensitive adhesive layer and the rewind tension used to produce a final roll of tape [EX 3042B] as described in Example 1, rolls of tape [EX 3042B] were produced having different amounts of the pressure-sensitive adhesive and using three different rewind tensions (i.e., 25 oz/in-w, 28 oz/in-w and 35 oz/in-w). The resulting samples were then tested for unwind force, as well as for standard peel force, standard shear force, and tensile strength.

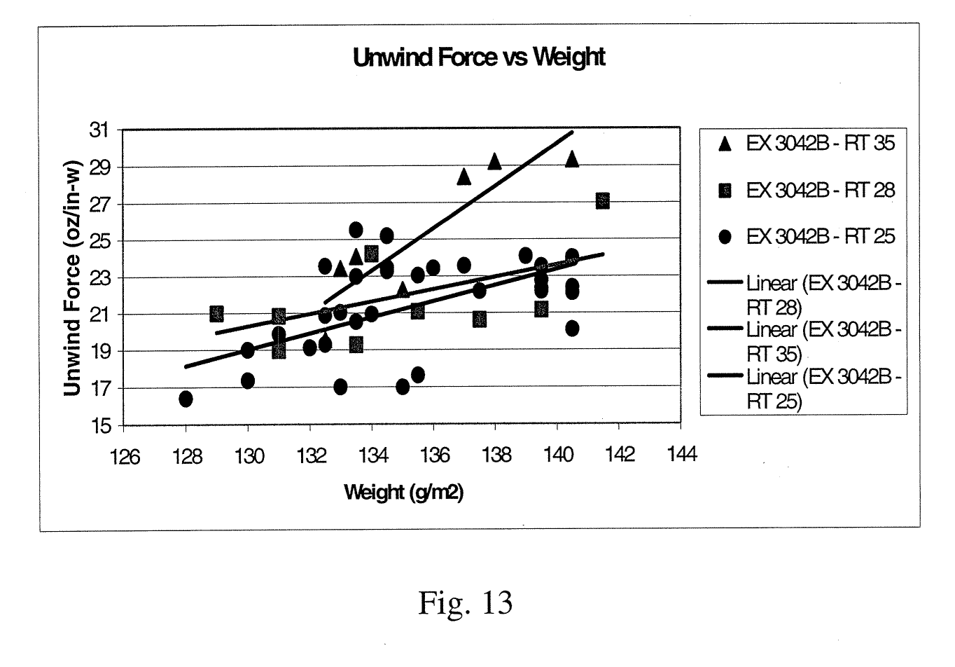

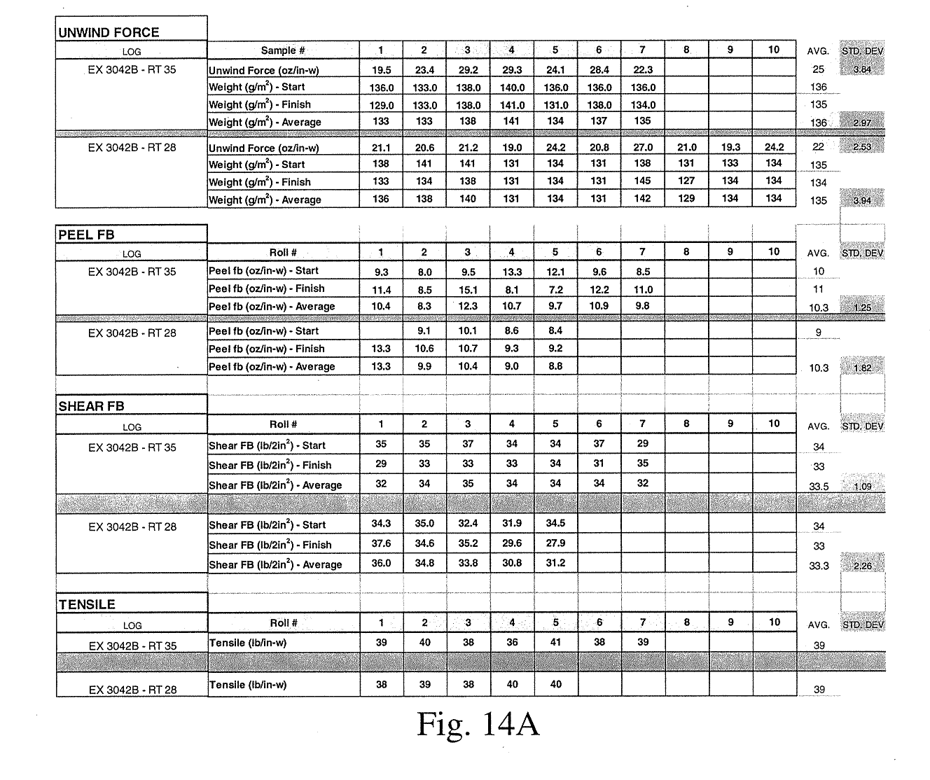

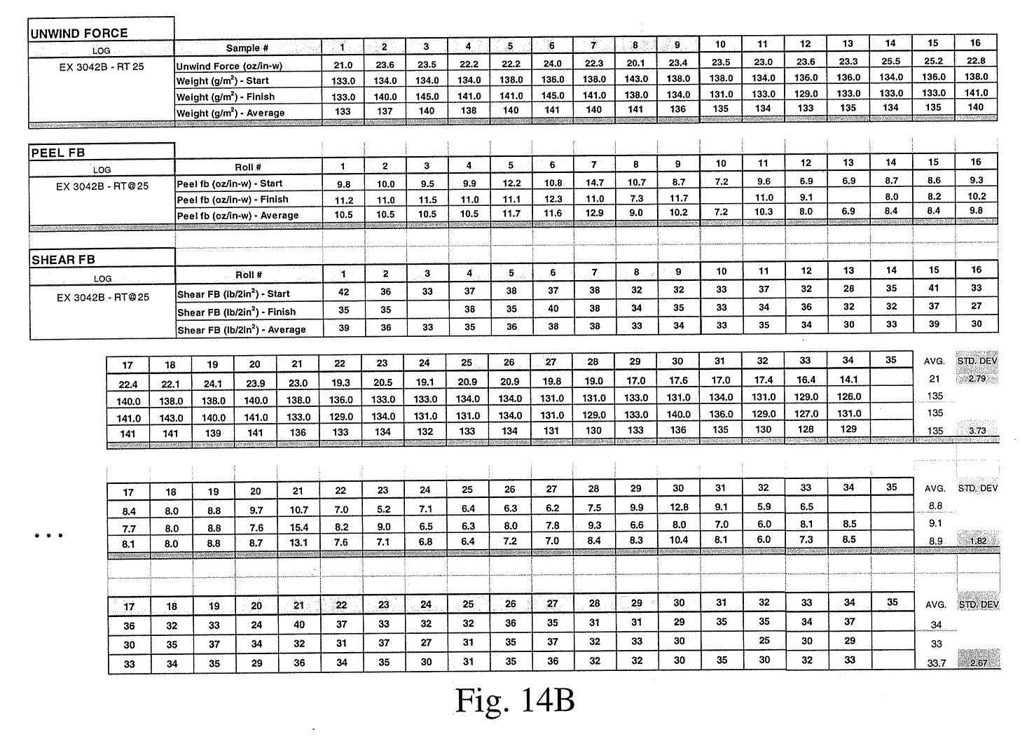

The results of the unwind force testing are shown in the graph in FIG. 13 and the complete results for each of the samples tested are summarized in the tables shown in FIGS. 14A and 14B. The results in FIG. 13 indicate that tape samples carrying greater amounts of the pressure-sensitive adhesive generally had greater unwind force requirements. The relative amount of pressure-sensitive adhesive is reflected in the total weight (g/m²) of the each sample; a sample with a higher total weight has a higher amount of pressure-sensitive adhesive. The correlation between amount of pressure sensitive adhesive and force required to unwind the sample was particularly significant for the tape samples that had been rewound at the highest rewind tension of 35 oz/in-w. Rolls produced using rewind tensions of 25 oz/in-w produced a range of useable unwind force measurements ranging from of 14.1 oz/in-w to 25.5 oz/in-w (avg. of 21 oz/in-w), while rolls produced using rewind tensions of 28 oz/in-w produced a range of useable unwind force measurements ranging from of 19.0 oz/in-w to 27.0 oz/in-w (avg. of 22 oz/in-w). In contrast, rolls produced using a rewind tensions of 35 oz/in-w produced a range of higher than optimal (but still useable) unwind force values ranging from of 19.5 oz/in-w to 29.3 oz/in-w (avg. of 25 oz/in-w). The results indicate that a wide range of desired unwind properties can be achieved by adjusting the amount of pressure-sensitive adhesive coating and/or the rewind tension used to wind the final roll of the binder-backed pressure sensitive adhesive tape.

### Example 6

### Effect of Defoamer on Binder in Peel Force Test of Backing from Two Standard Adhesive Layers

In order to investigate the effect of the presence of defoamer in the binder on the resulting adhesiveness of the backing to a pressure-sensitive adhesive layer, backings carrying polychloroprene-based binders, having varying amounts of defoamer, were made. The peel force required to peel the backings from two standard adhesive surfaces, i.e., the adhesive layer of #150 Trainer Tape (#150 TT), and to the adhesive layer [2023-52-B] of Example 1, was measured. The binder included Dispercoll® C-74 and either 0% or 2% of Foamaster® NDW defoamer. The peel force of the backings from the adhesive layers was measured as described above.

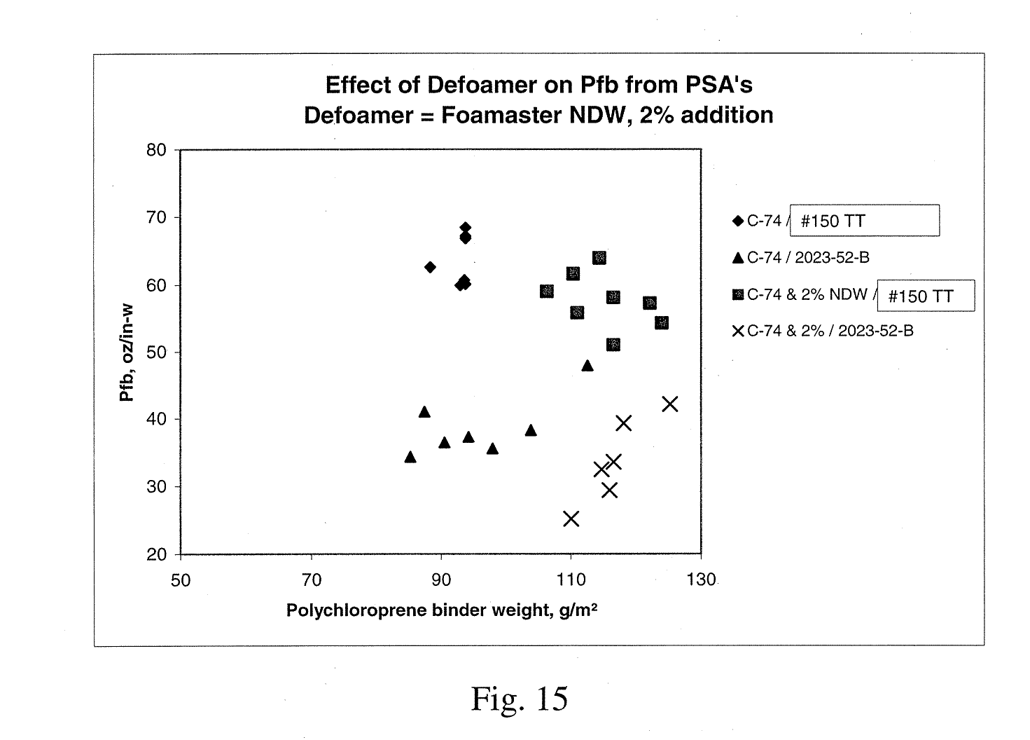

The results are summarized in FIG. 15. The results show that for tests performed on both of the different adhesive layers, the presence of 2% defoamer in the binder resulted in a reduction in the force required to peel the backing from the adhesive layer. The addition of the binder also increased the weight of the binder, which is shown along the x-axis of the plot shown in FIG. 15. For example, for a binder including Dispercoll® C-74 and 0% Foamaster® NDW, tested against the #150 TT surface (diamonds), addition of 2% Foamaster® NDW (squares) resulted in an approximately 15-20% reduction in peel force from the surface. Also, for the binder including Dispercoll® C-74 and 0% Foamaster® NDW, tested against the [2023-52-B] surface of the adhesive layer of Example 1 (triangles), addition of 2% Foamaster® NDW (X's) also resulted in an approximately 15-20% reduction in peel force from the surface. Thus, it appears that the presence of defoamer in the binder does materially affect the adhesion of a backing carrying that binder to the surface of a pressure-sensitive adhesive.

### Example 7

### Dry and Wet Extensibility Measurements for Tape of Example 1 and Other Commercial Tapes

The extensibility of the [EX 3042B] tape of Example 1 was compared to commercially available tapes. Specifically, a standard extensibility test as described above was performed on the [EX 3042B] tape, on J&J Coach Tape (Johnson & Johnson, New Brunswick, N.J.), and on J&J Zonas Tape (Johnson & Johnson, New Brunswick, N.J.). The extensibility of the tapes was tested both dry and wet.

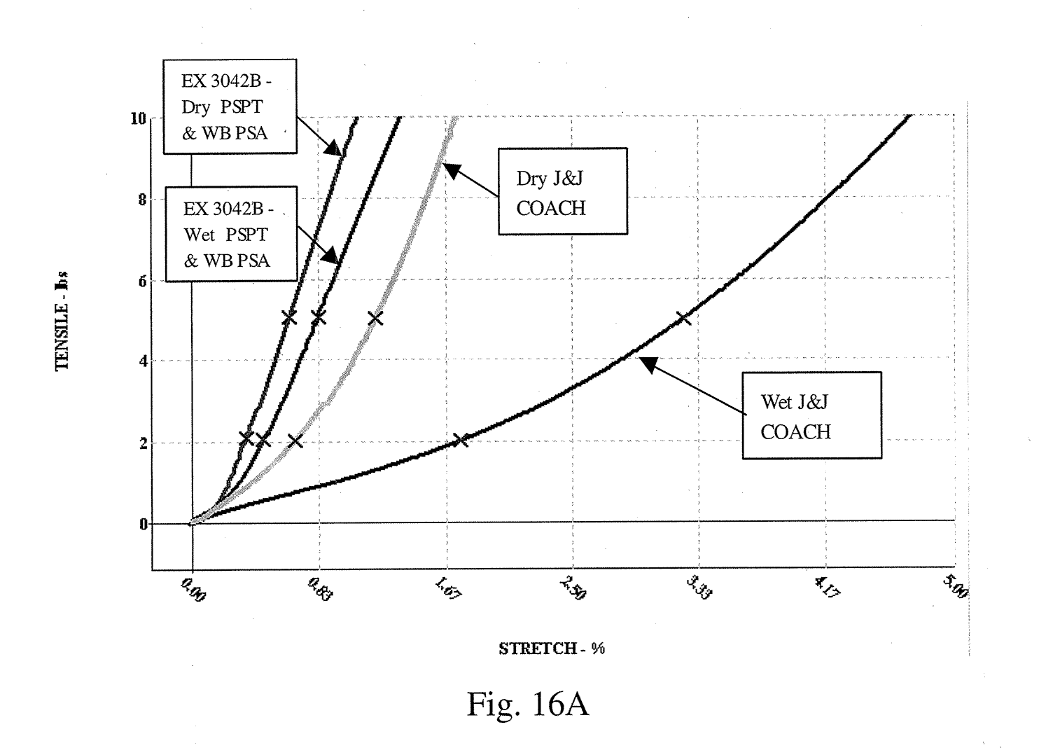

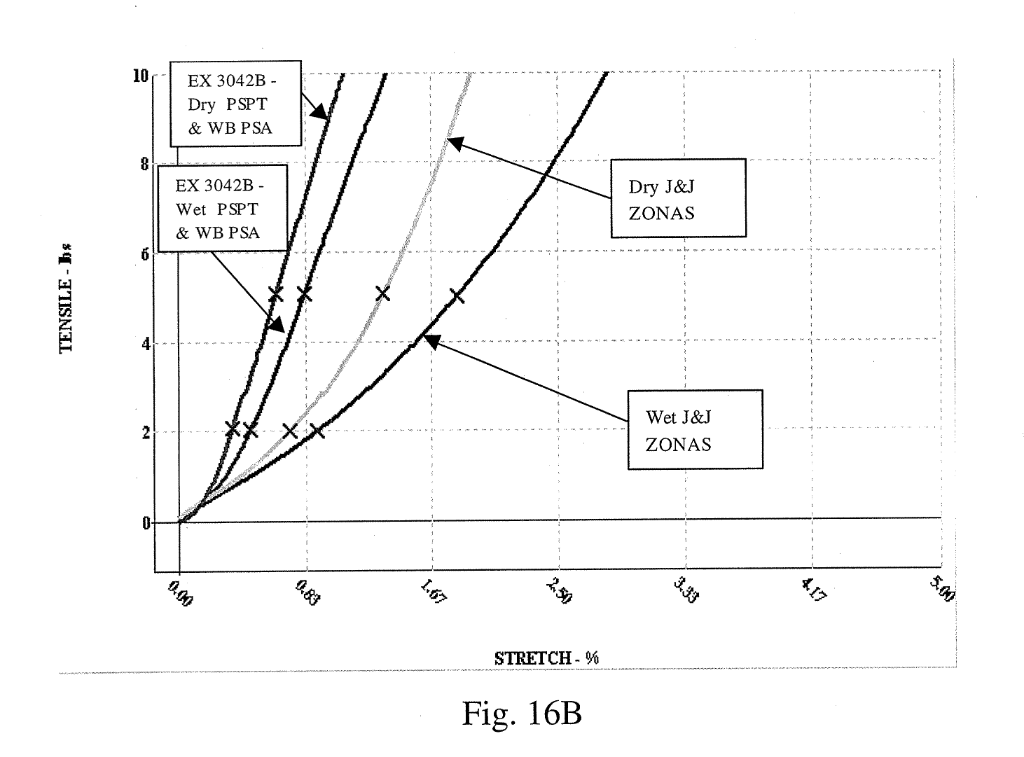

The results of the comparison of the [EX 3042B] tape and J&J Coach Tape are summarized in FIG. 16A. The dry [EX 3042B] tape can clearly be seen as having a lower stretch than the dry J&J Coach tape, both at relatively low tensile loads (e.g., 2 pounds of force) and relatively high tensile loads (e.g., 5 pounds of force). Additionally, the wet [EX 3042B] tape can clearly be seen as having a dramatically lower stretch than the dry J&J Coach tape at relatively low tensile loads (e.g., 2 pounds of force), and particularly at relatively high tensile loads (e.g., 5 pounds of force). In other words, the extensibility of the [EX 3042B] tape does not significantly change when the tape is wet, especially as compared with the J&J coach tape.

The results of the comparison of the [EX 3042B] tape and J&J Zonas Tape are summarized in FIG. 16B. The results appear fairly similar to those shown in FIG. 16A, although it appears that the extensibility of the J&J Zonas tape changes by a smaller margin when wet than did the J&J Coach Tape. In summary, the [EX 3042B] tape has a lower stretch than the J&J Coach Tape and the J&J Zonas Tape, under both wet and dry conditions. The extensibility of the [EX 3042B] tape does not substantially change when wet, for example, by less than about 0.25% at a tensile force of 2 pounds, and by less than about 0.5% at a tensile force of 5 pounds.

### Example 8

### Comparison of Water Vapor Transfer Rates for Tape of Example 1 and Other Commercial Tapes

One test of breathability is to measure the water vapor transmission rate of the tape. Water vapor transmission rate is the rate at which water vapor flows, per unit time and through unit area of a material, under specified temperature and humidity conditions. One standard test method for measuring the water vapor transmission of textile fabrics is ASTM E96-00 “Standard Test Methods for Water Vapor Transmission of Materials,” ASTM International, the entire contents of which are hereby incorporated by reference herein. Briefly, the test specimen is sealed to the open mouth of a test dish containing distilled water, and the assembly is placed in a controlled atmosphere. The assembly is then periodically weighed to determine the rate of vapor movement through the specimen from the water to the controlled atmosphere. The rate of water vapor transmission is generally expressed in units of grams of water transmitted per unit time through unit area of material (e.g., g/hour-m²).

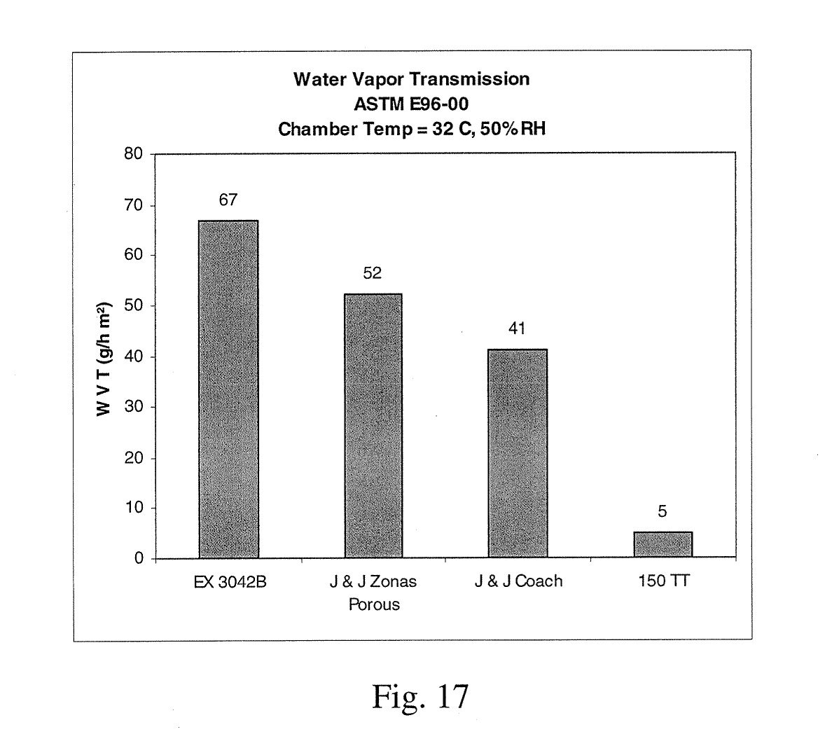

The results of the water vapor transmission tests are shown in FIG. 17. Briefly, the non-elastic tape of Example 1 [EX 3042B] had an approximately 29% higher water vapor transmission rate (67 g/h-m²) than J&J Zonas Porous tape (52 g/h-m²), and was also had an approximately 39% higher water vapor transmission rate than J&J Coach tape (41 g/h-m²). Furthermore, the #150 Trainer Tape (150 TT) had a water vapor transmission rate of only about 8% (5 g/h-m²) of that of the non-elastic tape of Example 1 [EX 3042B]. The results show that the non-elastic tape of Example 1 has superior breathability that would provide superior performance, particularly in athletic applications. In particular, these results demonstrate that a critical property affecting skin maceration and associated irritation and loss of adhesive properties, i.e., the water vapor transfer rate, is significantly improved in at least some embodiments over comparable commercially available tapes that are currently available.

Those skilled in the art will recognize, or be able to ascertain, using no more than routine experimentation, numerous equivalents to the specific substances and procedures described herein. Such equivalents are intended to be encompassed in the scope of the following claims.

Other embodiments are within the following claims.

What is claimed is:

1. An adhesive article with a nonstick backing comprising:
a backing comprising a first non-woven fabric carrying a binder, the binder having an elastomer selected from the group consisting of polychloroprene, butadiene-styrene copolymer, butadiene-styrene-acrylonitrile copolymer, and mixtures thereof; and
a pressure-sensitive adhesive layer applied to a surface of the backing, the adhesive layer comprising a fabric or a second non-woven fabric carrying a pressure-sensitive adhesive.

2. The article of claim 1, wherein the adhesive layer is laminated or bonded to the backing.

3. The article of claim 1, wherein the backing of the assembled article reversibly adheres to the adhesive layer of another such adhesive article.

4. The article of claim 1, wherein the article is wound upon itself to form overlying layers.

5. The article of claim 4, wherein the backing is on the outside of the wound article.

6. The article of claim 1, wherein the backing is selected so that if the article is wound upon itself to form overlying layers, when the article is unwound the backing releases from an overlying adhesive layer without undue force.

7. The article of claim 6, wherein the backing releases from the overlying adhesive layer with ordinary hand force.

8. The article of claim 7, wherein the backing of an underlying layer of the adhesive article releases from the adhesive layer of an overlying layer of the adhesive article without separating from the adhesive layer applied to the surface of the backing.

9. The article of claim 1, wherein if the article is wound upon itself to form overlying layers under standard test conditions, the backing releases from the overlying adhesive layer with an unwinding force of about 20 ounces/inch-width in a standard unwind force test.

10. The article of claim 9, wherein the standard test condition comprises a winding force of about 25 ounces/inch-width.

11. The article of claim 1, wherein if the article is wound upon itself to form overlying layers under standard test conditions, the backing releases from the overlying adhesive layer with an unwinding force of less than about 35 ounces/inch-width in a standard unwind force test.

12. The article of claim 1, wherein if the article is wound upon itself to form overlying layers, the pressure-sensitive adhesive provides an overlap adhesion and shear strength sufficient to prevent unwind of the wound article without the use of sufficient force.

13. The article of claim 1, wherein the type and amount of pressure-sensitive adhesive are selected to provide an overlap adhesion and shear strength sufficient to provide a peel strength of about 9 ounces/inch-width in a standard peel strength test.

14. The article of claim 13, wherein the standard peel strength test comprises rolling the article five times with a 5 pound roller.

15. The article of claim 1, wherein the type and amount of pressure-sensitive adhesive are selected to provide an overlap adhesion and shear strength sufficient to provide a shear strength of about 16 pounds/inch² in a standard shear strength test.

16. The article of claim 15, wherein the standard shear strength test comprises rolling the article five times with a 5 pound roller.

17. The article of claim 1, wherein the type and amount of pressure-sensitive adhesive are selected to adhere the adhesive layer to the backing with a strength sufficient to allow for orthopedic support in a joint strapping application.

18. The article of claim 1, wherein the article is soft and conformable.

19. The article of claim 1, wherein the adhesive layer has a porosity greater than that of the backing.

20. The article of claim 19, wherein the adhesive layer has an overall open area of at least about 15% of the article.

21. The article of claim 1, wherein the backing has at least about 10% open area.

22. The article of claim 1, wherein the article has an overall air permeability of at least about 100 ft³/minute.

23. The article of claim 1, wherein the article has a water vapor transfer rate of at least about 1,000 grams/day-m².

24. The article of claim 1, wherein the article has a water vapor transfer rate of at least about 1,400 grams/day-m².

25. The article of claim 1, wherein the backing and adhesive layer are selected so that the article is hand-tearable in at least one of the transverse and longitudinal directions.

26. The article of claim 25, wherein the fabric of the adhesive layer comprises warp yarns running in the machine direction and weft yarns running in the cross direction, the weft yarns having a higher denier than the warp yarns.

27. The article of claim 26, wherein the warp yarns have a denier in the range of 20 to 80, and the weft yarns have a denier in the range of 50 to 200.

28. The article of claim 26, wherein the warp yarns have a density in the range of 9 yarns/inch to 24 yarns/inch, and wherein the weft yarns have a density in the range of 9 yarns/inch to 18 yarns/inch.

29. The article of claim 26, wherein the warp yarns have a denier of about 30 and a density of about 18 yarns/inch, and the weft yarns have a denier of about 70 and a density of about 12 yarns/inch.

30. The article of claim 1, wherein the article is pliable.

31. The article of claim 1, wherein the article is suitable for strapping.

32. The article of claim 1, wherein the article is substantially non-elastic.

33. The article of claim 1, wherein the article is elastic.

34. The article of claim 1, further comprising an elastic layer applied to at least one of the backing and the adhesive layer.

35. The article of claim 34, wherein the elastic layer is laminated to at least one of the backing and the adhesive layer.

36. The article of claim 34, wherein the elastic layer is positioned between the first non-woven fabric and the adhesive layer.

37. The article of claim 34, wherein the elastic layer is elastic in a direction extending longitudinally of the article.

38. The article of claim 34, wherein the elastic layer comprises individual elastic strands spaced transversely of the article relative to each other and extending longitudinally of the article.

39. The article of claim 34, wherein the article is longitudinally extensible by at least about 10% during normal use.

40. The article of claim 34, wherein the article is longitudinally extensible by at least about 20% during normal use.

41. The article of claim 34, wherein the article is longitudinally extensible by at least about 100% during normal use.

42. The article of claim 34, wherein the article is longitudinally extensible by at least about 100% in a standard extensibility test, the test comprising measuring the % stretch of a 10 cm×30 cm piece of the article that occurs upon application of 5 lb of force along a 10 cm edge of the piece of the article.

43. The article of claim 1, wherein the backing further comprises a warp-knit weft-insertion or woven scrim fabric laminated to the first non-woven fabric.

44. The article of claim 43, wherein the binder laminates the warp-knit weft-insertion or woven scrim fabric to the first non-woven fabric.

45. The article of claim 43, wherein the binder substantially locks the fibers of the warp-knit weft-insertion or woven scrim fabric so as to provide for effective hand-tear.

46. The article of claim 43, wherein the warp-knit weft-insertion or woven scrim fabric is positioned between the first non-woven fabric and the adhesive layer.

47. The article of claim 43, wherein the first non-woven fabric is positioned between the warp-knit weft-insertion or woven scrim fabric and the adhesive layer.

48. The article of claim 43, wherein the warp-knit weft-insertion or woven scrim fabric comprises polyester.

49. The article of claim 43, wherein the warp-knit weft-insertion or woven scrim fabric has a weight of about 18 g/m².

50. The article of claim 1, wherein the binder substantially coats the outer surface of the first non-woven fabric.

51. The article of claim 1, wherein the binder is cohesive.

52. The article of claim 1, wherein the polychloroprene comprises poly-2-chloro-1,4-butadiene monomeric units.

53. The article of claim 1, wherein the binder comprises polychloroprene, non-silicone defoamer, titanium dioxide whitener, antioxidant, and thickener.

54. The article of claim 1, wherein the butadiene-styrene comprises butadiene-styrene random copolymer.

55. The article of claim 1, wherein the butadiene-styrene-acrylonitrile comprises butadiene-styrene-acrylonitrile random copolymer.

56. The article of claim 1, wherein the first non-woven fabric is porous.

57. The article of claim 1, wherein the first non-woven fabric has a weight of about 7.5 g/m² to about 30 g/m².

58. The article of claim 1, wherein the first non-woven fabric has a weight of about 10 g/m².

59. The article of claim 1, wherein the first non-woven fabric comprises at least one of polypropylene, nylon, polyester, and cellulose.

60. The article of claim 59, wherein the polypropylene comprises at least one of wet laid, meltblown, and spunbond polypropylene.

61. The article of claim 1, wherein the pressure-sensitive adhesive substantially coats the outer surface of the fabric or second non-woven fabric of the adhesive layer.

62. The article of claim 1, wherein the pressure-sensitive adhesive comprises a solvent-based pressure-sensitive adhesive.

63. The article of claim 1, wherein the pressure-sensitive adhesive comprises a water-based pressure-sensitive adhesive.

64. The article of claim 1, wherein the pressure-sensitive adhesive comprises at least one of acrylonitrile-butadiene copolymer, styrene-butadiene copolymer, acrylic polymer, natural rubber latex, and synthetic rubber latex.

65. The article of claim 64, wherein the pressure-sensitive adhesive comprises about 16% to about 36% natural rubber latex.

66. The article of claim 65, wherein the pressure-sensitive adhesive comprises about 26% natural rubber latex.

67. The article of claim 64, wherein the pressure-sensitive adhesive comprises a mixture of natural rubber latex and synthetic rubber latex.

68. The article of claim 67, wherein the mixture of natural rubber latex and synthetic rubber latex comprises about 30% to about 70% of the pressure-sensitive adhesive.

69. The article of claim 68, wherein the mixture of natural rubber latex and synthetic rubber latex comprises about 54% of the pressure-sensitive adhesive.

70. The article of claim 64, wherein the pressure-sensitive adhesive comprises natural rubber latex, and wherein the natural rubber latex reduces adhesion between the backing and the adhesive layer.

71. The article of claim 1, wherein the pressure-sensitive adhesive further comprises a tackifier.

72. The article of claim 71, wherein the tackifier comprises a low molecular weight, aliphatic tackifying resin.

73. The article of claim 72, wherein the aliphatic tackifying resin is derived from at least one of a diene and a reactive olefin monomer.

74. The article of claim 71, wherein the tackifier comprises a solvent-free anionic hydrocarbon dispersion prepared from aliphatic C₅ hydrocarbon resin.

75. The article of claim 71, wherein the tackifier comprises a rosin ester.

76. The article of claim 75, wherein the rosin ester comprises a glycerol ester of rosin.

77. The article of claim 1, wherein the fabric or second non-woven fabric of the adhesive layer is porous.

78. The article of claim 1, wherein the fabric or second non-woven fabric of the adhesive layer is a high-strength, low stretch fabric.

79. The article of claim 1, wherein the fabric of the adhesive layer comprises a warp-knit weft-insertion fabric.

80. The article of claim 1, wherein the fabric of the adhesive layer comprises a woven scrim fabric.

81. The article of claim 1, wherein the fabric or second non-woven fabric of the adhesive layer comprises at least one of polyester, polypropylene, and polyamide.

82. The article of claim 1, wherein the fabric or second non-woven fabric of the adhesive layer has a weight of about 18 g/m².

83. The article of claim 1, wherein the fabric or second non-woven fabric of the adhesive layer has at least about 25% open area.

84. An adhesive article with a nonstick backing comprising:
a backing comprising a first non-woven fabric carrying a binder, the binder having an elastomer selected from the group consisting of polychloroprene, butadiene-styrene copolymer, butadiene-styrene-acrylonitrile copolymer, and mixtures thereof;
a pressure-sensitive adhesive layer coextensive with the backing, the adhesive layer comprising a fabric or a second non-woven fabric carrying a pressure-sensitive adhesive; and
an elastic layer in contact with at least one of the backing and the adhesive layer.

85. The article of claim 84, wherein the binder comprises a mixture of polychloroprene and butadiene-styrene copolymer.

86. The article of claim 84, wherein the binder comprises about 51 weight % polychloroprene and about 43 weight % butadiene-styrene copolymer.

87. The article of claim 84, wherein the elastic layer is laminated to at least one of the backing and the adhesive layer.

88. The article of claim 84, wherein the elastic layer is elastic in a direction extending longitudinally of the article.

89. The article of claim 88, wherein the elastic layer comprises individual elastic strands spaced transversely of the article relative to each other and extending longitudinally of the article.

90. The article of claim 84, wherein the elastic layer is positioned between the backing and the adhesive layer.

91. The article of claim 84, wherein the backing and adhesive layer partially contact each other through open areas in the elastic layer.

92. The article of claim 84, wherein the elastic layer comprises at least one of: lycra, spandex, polyester, natural rubber, polyisoprene, polybutadiene, diene-styrene copolymer, diene-acrylonitrile copolymer, polychloroprene, elastomeric ethylenepropylene copolymer, styrene-butadiene block copolymer, styrene-isoprene block copolymer, elastic polyurethane yarn, polyether type urethane, and polyester type urethane.

93. An adhesive article with a nonstick backing comprising:
a backing comprising a warp-knit weft insertion or woven scrim fabric and a first non-woven fabric carrying a binder, the binder having an elastomer selected from the group of polychloroprene, butadiene-styrene copolymer, butadiene-styrene-acrylonitrile copolymer, and mixtures thereof; and
a pressure-sensitive adhesive layer coextensive with the backing, the adhesive layer comprising a fabric or a second non-woven fabric carrying a pressure-sensitive adhesive.

94. The article of claim 93, wherein the article is extensible by less than about 2%.

95. The article of claim 93, wherein wetting the article does not substantially alter the extensibility of the article.

96. The article claim 93, wherein wetting the article changes the extensibility of the article by less than about 0.5% at a tensile force of 5 pounds.

97. The article of claim 93, wherein the article is extensible by less than about 2% during normal use.

98. The article of claim 93, wherein the article is extensible by less than about 2% until failure.

99. The article of claim 93, wherein the article is extensible by less than about 1%.

100. The article of claim 93, wherein the article is extensible by less than about 0.5%.

101. The article of claim 93, wherein the article is longitudinally extensible by less than about 2% when wet.

102. The article of claim 93, wherein the article is extensible by less than about 2% during normal use when wet.

103. The article of claim 93, wherein the article is extensible by less than about 2% until failure when wet.

104. The article of claim 93, wherein the article is longitudinally extensible by less than about 1% when wet.

105. The article of claim 93, wherein the article is longitudinally extensible by less than about 0.5% when wet.

106. An adhesive article with a nonstick backing comprising:
a pressure-sensitive adhesive layer, the adhesive layer comprising a fabric or a first non-woven fabric carrying a pressure-sensitive adhesive; and
a backing bonded to the adhesive layer, the backing comprising a second non-woven fabric carrying a binder, wherein the backing is soft and conformable and the binder provides suitable adhesive properties such that, when the article is wound upon itself to form overlying layers:
the backing of an article layer bonds sufficiently weakly to the adhesive layer of an overlying article layer so as to release from the overlying adhesive layer without undue force when unwinding the wound article, and
the backing of an article layer bonds sufficiently strongly to the adhesive layer to which it is bonded as not to separate from said adhesive layer when unwinding the wound article.

107. The article of claim 106, wherein the binder comprises an elastomer.

108. The article of claim 107, wherein the elastomer contributes to said release and separation properties of the backing.

109. The article of claim 107, wherein the elastomer comprises at least one of polychloroprene, butadiene-styrene copolymer, butadiene-acrylonitrile copolymer, butadiene-styrene-acrylonitrile copolymer, natural rubber latex, non-pressure sensitive acrylic, waterborne polyurethane, ethylene-vinyl acetate copolymer, and mixtures thereof.

110. The article of claim 107, wherein the elastomer comprises at least one of polychloroprene, butadiene-styrene copolymer, butadiene-styrene-acrylonitrile copolymer, and mixtures thereof.

111. A method of making an adhesive article, the method comprising:
coating a fabric or a first non-woven fabric with a pressure-sensitive adhesive to form a pressure-sensitive adhesive layer;
coating a second non-woven fabric with a binder to form a backing, the backing being soft and conformable, and the binder providing suitable adhesive properties such that, when the article is wound upon itself to form overlying layers:
the backing of an article layer bonds sufficiently weakly to the adhesive layer of an overlying article layer so as to release from the overlying adhesive layer without undue force when unwinding the wound article, and
the backing of an article layer bonds sufficiently strongly to the adhesive layer to which it is bonded as not to separate from said adhesive layer when unwinding the wound article; and
bonding the adhesive layer to the backing to form a pressure-sensitive adhesive article.

112. The method of claim 111, wherein the binder comprises an elastomer.

113. The method of claim 112, wherein the elastomer comprises at least one of polychloroprene, butadiene-styrene copolymer, butadiene-acrylonitrile copolymer, butadiene-styrene-acrylonitrile copolymer, natural rubber latex, non-pressure sensitive acrylic, waterborne polyurethane, ethylene-vinyl acetate copolymer, and mixtures thereof.

114. The method of claim 112, wherein the elastomer comprises at least one of polychloroprene, butadiene-styrene copolymer, butadiene-styrene-acrylonitrile copolymer, and mixtures thereof.

115. The method of claim 114, wherein the polychloroprene comprises poly-2-chloro-1,4-butadiene monomeric units.

116. The method of claim 114, wherein the binder comprises polychloroprene, non-silicone defoamer, titanium dioxide whitener, antioxidant, and thickener.

117. The method of claim 114, wherein the butadiene-styrene comprises butadiene-styrene random copolymer.

118. The method of claim 114, wherein the butadiene-styrene-acrylonitrile comprises butadiene-styrene-acrylonitrile random copolymer.

119. The method of claim 111, wherein coating the second non-woven fabric with the binder comprises saturating the second non-woven fabric with the binder.

120. The method of claim 111, wherein coating the fabric or the first non-woven fabric of the adhesive layer with the pressure-sensitive adhesive comprises saturating the fabric or the first non-woven fabric of the adhesive layer with the pressure-sensitive adhesive.

121. The method of claim 111, further comprising laminating a warp-knit weft-insertion or woven scrim fabric to the second non-woven fabric.

122. The method of claim 121, wherein the binder laminates the warp-knit weft insertion or woven scrim fabric to the second non-woven fabric.

123. The method of claim 122, comprising positioning the warp-knit weft-insertion or woven scrim fabric between the second non-woven fabric and the fabric or first non-woven fabric of the adhesive layer before bonding the backing to the adhesive layer.

124. The method of claim 122, wherein the binder substantially locks the fibers of the warp-knit weft-insertion or woven scrim fabric so as to provide for effective hand tear in the article.

125. The method of claim 111, further comprising laminating an elastic layer to at least one of the backing and the adhesive layer.

126. The method of claim 125, wherein the elastic layer is positioned between the backing and adhesive layer before bonding the backing to the adhesive layer.

127. The method of claim 126, wherein the adhesive layer at least partially contacts the backing through open spaces in the elastic layer.

128. The method of claim 126, wherein the elastic layer comprises individual elastic strands spaced transversely of the article relative to each other and extending longitudinally of the article.

129. The method of claim 111, wherein the pressure-sensitive adhesive coated on the fabric is about 50% dry when bonding the adhesive layer to the backing.

130. The method of claim 129, further comprising drying the article.

131. The method of claim 111, further comprising winding the article upon itself to form a roll.

132. An adhesive article with a non-stick backing, the article made by the process of:
coating a fabric or a first non-woven fabric with a pressure-sensitive adhesive to form a pressure-sensitive adhesive layer;
coating a second non-woven fabric with a binder to form a backing, the backing being soft and conformable, and the binder providing suitable adhesive properties such that, when the article is wound upon itself to form overlying layers:
the backing of an article layer bonds sufficiently weakly to the adhesive layer of an overlying article layer so as to release from the overlying adhesive layer without undue force when unwinding the wound article, and
the backing of an article layer bonds sufficiently strongly to the adhesive layer to which it is bonded as not to separate from said adhesive layer when unwinding the wound article; and
bonding the adhesive layer to the backing to form a pressure-sensitive adhesive article.

133. The article of claim 132, wherein the binder comprises an elastomer.

134. The article of claim 133, wherein the elastomer contributes to said release and separation properties of the backing.

135. The article of claim 133, wherein the elastomer comprises at least one of polychloroprene, butadiene-styrene copolymer, butadiene-acrylonitrile copolymer, butadiene-styrene-acrylonitrile copolymer, natural rubber latex, non-pressure sensitive acrylic, waterborne polyurethane, ethylene-vinyl acetate copolymer, and mixtures thereof.

136. The article of claim 133, wherein the elastomer comprises at least one of polychloroprene, butadiene-styrene copolymer, butadiene-styrene-acrylonitrile copolymer, and mixtures thereof.

137. The article of claim 132, wherein the article is wound upon itself to form overlying layers.

138. The article of claim 137, wherein the backing is on the outside of the wound article.

139. The article of claim 132, wherein the backing of an article layer bonds sufficiently weakly to the adhesive layer of an overlying article layer so as to release from the overlying adhesive layer with ordinary hand force.

140. An adhesive article with a non-stick backing, the article made by the process of:
coating a fabric or a first non-woven fabric with a pressure-sensitive adhesive to form a pressure-sensitive adhesive layer;
coating a second non-woven fabric with a binder comprising an elastomer selected from the group consisting of polychloroprene, butadiene-styrene copolymer, butadiene-styrene-acrylonitrile copolymer, and mixtures thereof, to form a backing, the backing being soft and conformable, and the binder providing suitable adhesive properties such that, when the article is wound upon itself to form overlying layers, the backing layer of the article bonds sufficiently weakly to the adhesive layer of an overlying article so as to release from the overlying adhesive layer of the overlying article without undue force when the article is unwound; and
bonding the adhesive layer to the backing to form a pressure-sensitive adhesive article, wherein the backing of the article bonds sufficiently strongly to the adhesive layer of the article to which it is bonded so as not to separate from said adhesive layer when unwinding the wound article.
